(19) United States
(12) Patent Application Publication
(10) Pub. No.: US 2024/0302718 A1
(43) Pub. Date: Sep. 12, 2024

(54) ILLUMINATION ASSEMBLY FOR A MACHINE VISION SYSTEM

(71) Applicant: COGNEX CORPORATION, Natick, MA (US)

(72) Inventors: José Fernández Dorado, Vaals (NL); Pablo Garcia Campos, Aachen (DE); Martijn Visser, Aachen (DE); Andreas Weber, Aachen (DE); Laurens Nunnink, Simpelveld (NL); Fabio Fioravanti, Aachen (DE)

(21) Appl. No.: 18/601,822

(22) Filed: Mar. 11, 2024

Related U.S. Application Data
(60) Provisional application No. 63/451,056, filed on Mar. 9, 2023.
(60) Provisional application No. 63/600,348, filed on Nov. 17, 2023.

(51) Int. Cl. G03B 15/05

(52) U.S. Cl. CPC G03B 15/05

(57) ABSTRACT

An illumination assembly for a machine vision system includes a housing comprising a first shelf defining a first position within the housing and a second shelf defining a second position within the housing. a circuit board disposed within the housing, a plurality of light sources disposed within the housing and configured to be coupled to the circuit board, and a plurality of illumination optics assemblies disposed within the housing and removably coupled to the housing. Each illumination optics assembly corresponds to one of the plurality of light sources. The housing is configured to support the circuit board at one of the first position or the second position within the housing based on an illumination optics assembly type of the plurality of illumination optics assemblies.

### CROSS-REFERENCE TO RELATED APPLICATIONS

This application is based on, claims priority to, and incorporates by reference in its entirety U.S. Ser. No. 63/451,056, filed Mar. 9, 2023, and entitled “Modular Illumination Assembly For A Machine Vision System,” and U.S. Ser. No. 63/600,348, filed Nov. 17, 2023, and entitled “Two Element Multicolor Illumination Assembly For A Machine Vision System.”

### FIELD

The present disclosure relates generally to machine vision systems and, more particularly, to an illumination assembly including a modular illumination assembly.

### BACKGROUND

Machine vision systems (also simply termed “vision systems”) use image acquisition devices that include image sensors to deliver information on a viewed subject. The system can then interpret this information according to a variety of algorithms to perform programmed decision-making or identification functions. For example, an image of an object containing features of interest to the system can be acquired by an on-board image sensor (also referred to as simply an “imager” or “sensor”) in the visible or near visible light range under appropriate illumination, which can be based upon ambient light or light provided by an internal or external illuminator.

Vision systems may be used for a variety of tasks in manufacturing, logistics and industry. A common task for vision systems is the reading and decoding of symbology (e.g., one—dimensional and two-dimensional codes—also termed “IDs”), which are used in a wide variety of applications and industries and can take the form of ID barcodes, 2D DataMatrix Codes, QR Codes and Dot-Codes, among other. The image sensor acquires images (typically grayscale or color, and in one, two, or three dimensions) of the subject or object, and processes these acquired images using an on-board or interconnected vision system processor. The processor often includes both processing hardware and non-transitory computer-readable program instructions (software) that perform one or more vision system processes to generate a desired output based upon the image's processed information. This image information is typically provided within an array of image pixels each having various colors or intensities. In the example of an ID reader (also termed herein, a “reader”), the user or an automated process acquires an image of an object that is believed to contain one or more barcodes, 2D codes or other ID types. The image is processed to identify encoded features, which are then decoded by a decoding process or processes to obtain the inherent alphanumeric data represented by the code.

Vision systems may also be used for other tasks such as, for example, surface and parts inspection, alignment of objects during assembly, measurement, and any other operations in which visual data is acquired and interpreted for use in further processes. For example, a vision system may be used to inspect objects (e.g., components or parts) on a production line (e.g., during manufacturing processes) to ensure that the objects meet predefined criteria. For example, each object may be expected to contain certain features or characteristics. In an inspection process, the image sensor of the vision system may acquire images of an object and the images may be processed (e.g., using a vision system processor) to identify features or characteristics of the object. The results of the inspection process may be provided to a display for viewing by an operator. If the object passes the inspection, the object may be kept on the production line for further processing and/or handling. If the object fails the inspection, the object may be marked and/or removed from the production line.

### SUMMARY

In accordance with an embodiment of the technology, an illumination assembly for a machine vision system includes a housing comprising a first shelf defining a first position within the housing and a second shelf defining a second position within the housing. a circuit board disposed within the housing, a plurality of light sources disposed within the housing and configured to be coupled to the circuit board, and a plurality of illumination optics assemblies disposed within the housing and removably coupled to the housing. Each illumination optics assembly corresponds to one of the plurality of light sources. The housing is configured to support the circuit board at one of the first position or the second position within the housing based on an illumination optics assembly type of the plurality of illumination optics assemblies.

In accordance with another embodiment of the technology, a machine vision system includes an image sensor assembly including an image sensor, an imaging optics assembly including a lens and coupled to the image sensor assembly, and an illumination assembly coupled to the imaging optics assembly. The illumination assembly includes a housing having an opening configured to receive the imaging optics assembly, a circuit board disposed within the housing, a plurality of light sources disposed within the housing and configured to be coupled to the circuit board, and a plurality of illumination optics assemblies disposed within the housing and removably coupled to the housing. Each illumination optics assembly corresponds to one of the plurality of light sources. The housing is configured to support the circuit board at one of a plurality of positions within the housing based on an illumination optics assembly type of the plurality of illumination optics assemblies.

In accordance with another embodiment of the technology, a method for manufacturing an illumination assembly includes providing a housing comprising a first shelf defining a first position within the housing and a second shelf defining a second position within the housing, selecting one of the first shelf or the second shelf based on a predetermined illumination optics assembly type for the illumination assembly, and positioning a circuit board on the selected one of the first shelf and the second shelf. The circuit board includes a plurality of light sources removably coupled to the circuit board. The method further includes positioning a set of illumination optics assemblies of the predetermined illumination optics assembly type in the housing. Each illumination optics assembly corresponds to one of the light sources and is disposed on top of the corresponding light source.

### BRIEF DESCRIPTION OF THE DRAWINGS

The present disclosure will hereafter be described with reference to the accompanying drawings, wherein like reference numerals denote like elements.

FIG. 1 is a perspective view of an illumination assembly in accordance with an embodiment of the technology;

FIG. 2 is an exploded view of a housing, thermal control assembly and circuit board of the illumination assembly of FIG. 1 in accordance with an embodiment of the technology;

FIG. 3A is a cross-section view of an illumination assembly in accordance with an embodiment of the technology;

FIG. 3B is a cross-sectional view an illumination assembly in accordance with an embodiment of the technology;

FIG. 4 is a schematic diagram of an example multispectral light assembly in accordance with an embodiment of the technology;

FIG. 5 is a cross-sectional view of a housing, thermal control assembly, circuit board, and light sources of an illumination assembly in accordance with an embodiment of the technology;

FIG. 6A is a front view of an illumination assembly with an example arrangement of light sources and light source openings in accordance with an embodiment of the technology;

FIG. 6B is a front view of an illumination assembly with an example arrangement of light sources and light source openings in accordance with an embodiment of the technology;

FIG. 7 is an exploded view of a machine vision system including an illumination assembly in accordance with an embodiment of the technology;

FIG. 8 is a block diagram of a machine vision system including an illumination assembly in accordance with an embodiment of the technology;

FIG. 9 illustrates an example illumination pattern of light sources and example illumination optics for a wide field of view in accordance with an embodiment of the technology;

FIG. 10 illustrates an example illumination pattern of light sources and example illumination optics for an intermediate field of view in accordance with an embodiment of the technology;

FIG. 11 illustrates an example illumination pattern of light sources and example illumination optics for a narrow field of view in accordance with an embodiment of the technology;

FIG. 12 illustrates a method for controlling an illumination assembly with multispectral light sources for generating an image in accordance with an embodiment of the technology;

FIG. 13 is a graph illustrating a timing configuration using multispectral exposures for generating an image using an illumination assembly with multispectral; light sources in accordance with an embodiment of the technology;

FIG. 14 is a graph illustrating a timing configuration using a single exposure for generating an image using an illumination assembly with multispectral light sources in accordance with an embodiment of the technology;

FIG. 15 is a schematic diagram of an example light assembly in accordance with an embodiment of the technology;

FIG. 16 is a schematic diagram of an example arrangement of two light assemblies of FIG. 15 for an illumination assembly in accordance with an embodiment of the technology; and

FIG. 17 is a perspective view of an example arrangement of a plurality of light assemblies of FIG. 15 for an illumination assembly in accordance with an embodiment of the technology.

### DETAILED DESCRIPTION

Visions systems may be used in a variety of applications including reading and decoding IDs (e.g., barcodes), logistics (e.g., presentation mode), inspecting objects and surfaces, alignment of objects during assembly, measurement, factory automation, and any other operations in which visual data is acquired and interpreted for use in further processes. ID (e.g., barcode) readers are generally configured to track and sort objects, including along a line (e.g., a conveyor) in manufacturing and logistics operations. The ID reader, or more typically, a plurality (constellation) of readers can be positioned over the line (or otherwise) at an appropriate viewing angle(s) to acquire any expected ID codes on the face(s) of respective objects as they each move through the field of view. The ID reader can also be provided in a handheld configuration that allows the user to move from object to object, for example, on an inspection floor and vary the distance or relative angle between the reader and object surface at will. More generally, the focus distance of the ID reader with respect to the object can vary, depending on the placement of the reader with respect to the line and the size of the object.

Vision systems for inspection are generally configured to capture an image of an object (e.g., a component or part) on a production or assembly line, processing the image to determine if the object meets a predefined criteria (e.g., one or more expected features are present), and report the inspection results. Such machine vision systems may aid in the inspection, assembly, and/or handling of various types of articles, parts, and devices, including automotive parts (e.g., fuses, gaskets, and spark plugs), electrical components (e.g., connector pins, keyboards, LED, LCD displays), medical and pharmaceutical products (e.g., disposable test kits, syringes, needles, and date-lot codes), and consumer products (e.g., razor blades and floppy disks).

In operation, some vision systems (e.g., ID readers or inspection systems) or associated lighting attachments function to illuminate the scene containing one or more objects (e.g., ID's, components or parts). For an ID reader, this illumination can include aimers that project a colored dot on the region of interest in the imaged scene, whereby the user can center the image axis of the reader on the barcode within the imaged scene. Illumination for a vision system can also include general illumination to allow acquisition of appropriately detailed images. The illuminated scene is then acquired by an image sensor within the imaging system through optics. The array of pixels of the sensor is exposed, and the electronic value(s) generated for each pixel by the exposure is/are stored in an array of memory cells, as can be termed the “image” of the scene. In the context of an ID-reading application, the scene can include an object of interest that has one or more IDs of appropriate dimensions and type (e.g., DPM codes, printed barcodes, etc.). The ID(s) are part of the stored image. In the context of an inspection system, the scene can include an area encompassing all pertinent portions of the object of interest in the field of view and the area around the object of interest.

Vision systems may utilize monochromatic or multispectral light sources for illumination of an object. Multispectral light sources may be used for various applications where color (or other multi-wavelength) images are advantageous. As used herein, a multispectral light source is a light source that can separately generate a plurality of different wavelengths of light (e.g., a light source assembly that includes a plurality of distinct light sub-assemblies, each of which can generate a different respective wavelength peak or band). For example, multispectral light sources such as red, green, blue, yellow, infrared (IR), or ultraviolet (UV) light emitting diodes (LEDs) may be used in a vision system to provide multispectral capabilities.

Generally, different configurations of machine vision systems, such as with different orientations or types of imaging sensors, different imaging lenses, different light sources (e.g., mono-color or multispectral), or other optical modules (e.g., aimers, distance finders, etc.) may be needed to optimally perform specific machine vision tasks. For example, as noted above, machine vision systems can be configured to capture images of an object, analyze the images to identify relevant characteristics, actions, and so on, and instruct various devices (e.g., manufacturing or sorting device) based upon the image analysis. In this context, an optimal type or orientation of an imaging sensor, an optimal type of lens, an optimal type of light source, or other optical device may be directly linked to the relative orientation of an object to be captured, the particular type of object or environment (e.g., relative to lighting considerations) or other factors. Accordingly, it may be useful for operators to be able to easily swap particular imaging sensors, lenses, light sources, or other optical devices for use with a particular machine vision system.

Some conventional imaging systems can be configured for capturing a specific object or for performing predetermined processes under particular conditions, with optical devices that are fixed in limited, predetermined and sometimes non-changeable orientations. Correspondingly, some conventional machine vision systems may be generally equipped to receive and operate with only a single (and single type of) optical device at any given time. Further, while some conventional systems can allow switching of optical devices, such as via the interchange of lenses with similar mounting configurations, these systems may not be particularly adaptable to accommodate wide varieties of operations and operating conditions.

Among other aspects, the present disclosure describes an illumination assembly that can provide a single mechanical or optomechanical structure or package that may be used for different light types and illumination optics. In some embodiments, the illumination assembly may be used for either monocolor or multispectral (multicolor) light sources and the corresponding illumination optics for the monocolor or multispectral light sources. In some embodiments, the illumination assembly can include a housing that includes a plurality of shelves that define positions within the housing, for example, a first shelf that defines a first position and a second shelf that defines a second position. A circuit board (e.g., a printed circuit board (PCB)) and a thermal control assembly (e.g., a heat conductor such as a heat sink) may be positioned on or coupled to one of the shelves in the housing. In some embodiments a plurality of light sources may be positioned on and coupled to the circuit board and the circuit board may be thermally coupled to the thermal control assembly. A plurality of illumination optics assemblies may be removably coupled to the housing and each illumination optics assembly can correspond to one of the plurality of light sources. In some embodiments, the position for the circuit board and thermal control assembly within the housing can be selected based on the type of illumination optics assemblies being used in the illumination assembly. In some embodiments, the plurality of light sources may be, for example, monocolor light sources, infrared light sources, or multispectral light sources. In some embodiments, the plurality of light sources are light emitting diodes (LEDs). In some embodiments, the LEDs may be high power LEDs. In an embodiment where the plurality of light sources are multispectral light sources, the multispectral light sources may be, for example, a RGB LED, an RGBW LED, a RGB(IR) LED, an RGBY LED, an IR and Red LED, a White and Red LED or other RGB or multi-wavelength LED type. In some embodiments, each illumination optics assembly can be a lens and the circuit board can be positioned on the first shelf in the first position. The first position can be configured to provide sufficient space in which the illumination optics may be located within the housing. In some embodiments, each illumination optics assembly can include at least one lens and a light pipe, and the circuit board can be positioned on the second shelf in the second position. In some embodiments, for example, the illumination optics may include a light pipe and a projection lens. In some embodiments, in another example, the illumination optics can be a two element illumination optics assembly that includes a light pipe assembly (e.g., a light pipe and a first lens positioned on an exit surface of the light pipe) and a second lens. Accordingly, in some embodiments, the second position can be a lower position in the housing than the first position in order to provide sufficient space for illumination optics assemblies that may have a greater length.

Advantageously, the light sources and the illumination optics assemblies may be removable from the housing so that they may be interchangeable to provide different light architectures using the same mechanical housing or package. For example, as mentioned above, the light sources may be monocolor light sources or the light sources may be multispectral lights sources. The selection of monocolor or multispectral light sources may be based on the application of the machine vision system in which the illumination assembly will be incorporated. Advantageously, the same circuit board footprint including the position and orientation of the light sources on the circuit board can be used for both monocolor and multispectral light sources. In addition, the position of the circuit board within the housing can advantageously be changed to accommodate the appropriate illumination optics assemblies. In some embodiments, the interchangeable illumination optics assemblies (or elements of the illumination optics assemblies), for example, lenses, may be selected and changed based on the type of and parameters of the image sensor assembly and/or the imaging optics assembly which will be used with the illumination assembly in the machine visions system. In some embodiments, more than one type of illumination optics assembly can be included in the illumination assembly (e.g., different lenses can be used for one or more of the light sources). Accordingly, the same illumination assembly mechanical enclosure may advantageously be used for both monocolor and multispectral illumination.

The illumination assembly can be used to advantageously provide dynamic illumination for a wide variety of different FOVs and working distances. In some embodiments, the illumination assembly may be used with an imaging optics assembly with fixed focal length lenses. In some embodiments, the illumination assembly may be used with an imaging optics assembly that includes zoom lenses. In some embodiments, the illumination assembly may include a distance sensor (e.g., a time of flight (TOF) sensor) and the distance (e.g., working distance) measured by the distance sensor may be used to determine how to illuminate the scene. Accordingly, multiple illumination configurations for either monocolor or multispectral light can be deployed (e.g., based on the illumination optics and controlling which LEDS are on or off) in a single optomechanical package. By dynamically illuminating a subset of the light sources with a corresponding lens of a particular type (e.g., associated with a with a particular emission pattern, FOV, etc.), in some embodiments the illumination assembly can be configured to provide the correct opening angle of the light for a number of working distances. The illumination (or light beam) output, intensity, and the geometry of the light pattern does not require different physical positions or orientations of the light sources on the circuit board. As mentioned above, the circuit board has the same footprint including locations of the light sources regardless of which type of light sources (monocolor or multispectral) are used. The output, intensity and light patter geometry may be determined or controlled based on, for example, which light sources are illuminated and the types of illumination optics assemblies. The disclosed illumination assembly can provide more consistent light pattern geometries, larger FOV sizes and longer working distances. The illumination assembly can provide sufficient brightness and FOV coverage at different working distances.

In some embodiments, the disclosed illumination assembly is a modular assembly and can be interchangeably attached to different image sensor assemblies. Different models or types of images sensors may require different illumination and fields of view (FOVs). It may be advantageous to move the illumination assembly from one image sensor assembly to another. For example, the interface between the illumination assembly and the image sensor assembly may be the same for any type of image sensor assembly. In some embodiments, the illumination assembly may also be interchangeably attached to different imaging optics assemblies (e.g., lens assemblies). For example, different applications may require different types of imaging optics assemblies (e.g., solid lenses and/or liquid lenses). In addition, different applications may require different models or types of liquid lenses. Advantageously, the illumination assembly may include an interface (e.g., both mechanical and/or electrical connections) that may be used for a plurality of types of imaging optics assemblies.

As mentioned above, in some embodiments, multispectral light sources may be used for various applications where color (or other multi-wavelength) images are advantageous. However, multispectral (or multicolor) applications for machine vision systems can experience issues with efficiency, limited light output and direction of the lighting system. Various issues can arise when, for example, an image sensor and illumination assembly of a machine vision system are not aligned along the same point or when multiple light sources from different positions attempt to illuminate the same target or target area. While some solutions have been introduced, such as using the same illumination elements in a linear or circular pattern, these solutions often introduce problems with light distribution homogeneity. Even in a well-planned system where light beam cones are designed not to overlap, a non-homogeneous light distribution can still occur due to tolerances which can result in bright or dark spots. Many prior solutions will utilize a diffuser to help smooth the light distribution in order to get rid of bright or dark spots but at the expense of homogeneity. Another issue can arise when using multicolor LEDs in that such light sources are composed of multiple chips, each emitting a different color. The color of the light from each color chip can change from angle to angle in the far field which can mean that the color on a target in the image plane may not be homogeneous.

In another aspect, the present disclosure describes a light assembly for an illumination system that can include a monocolor or multispectral light source, and a two element illumination optics assembly that advantageously provides homogeneity while providing increased power output and removing the need for external illumination. In some embodiments that include a multispectral light source, the two element illumination optics assembly can also provide color mixing. In some embodiments, the disclosed two element illumination optics assembly can include a light pipe (or light guide or mixing rod) assembly that can include a light pipe with a first lens formed on an exit surface of the light pipe, and a second lens. Advantageously, in some embodiments, the light pipe and first lens are formed as a single unitary piece which can, for example, simplify manufacturing and reduce costs. In some embodiments, the second lens can be positioned in front of the light pipe assembly with a spatial shift and a tile angle with respect to an optical axis of the light pipe. In some embodiments of an illumination assembly with a plurality of light assemblies, the spatial shift and the tilt angle of the second lens for each light assembly projects a light beam to a target area such that the plurality of light assemblies output a homogeneous light distribution at the target area. The spatial shift and tilt angle of each second lens can be selected so that the area onto which each second lens projects the light beam is the same area. In addition, the plurality of light assemblies with the disclosed two element illumination optics assemblies can advantageously reduce (e.g., minimize) the amount of stray light with respect to the target area. In some embodiment the plurality of light assemblies with the disclosed two element illumination optics assemblies can be positioned so that a sum of a light distribution of each light beam projected by each second lens onto the target area is homogeneous or substantially homogeneous. Advantageously, the disclosed two element illumination optics assembly does not require a diffuser (which can increase the etendue of a illumination assembly which can decrease efficiency and affect the homogeneity of the system) to achieve good color mixing properties or homogeneity. Accordingly, the two elements illumination optics assembly can provide direct light.

The disclosed two element illumination optics assembly can be used in an illumination system to provide dynamic illumination for a wide variety of different FOVs and working distances. For example, in some embodiments, an illumination system with multiple two element illumination optics assemblies (corresponding to multiple light sources) can project uniform light patterns with direct light which enables larger working distances (e.g., 1.0 m). In addition, the disclosed two element illumination optics assembly can be included in an illumination assembly that can be integrated with a reader or image sensor of a machine vision system and therefore, can eliminate the need for external illumination. For example, in some embodiments, the disclosed two element illumination optics assembly may be used in the disclosed illumination assembly that can provide a single mechanical or optomechanical structure or package that may be used for different light types and illumination optics.

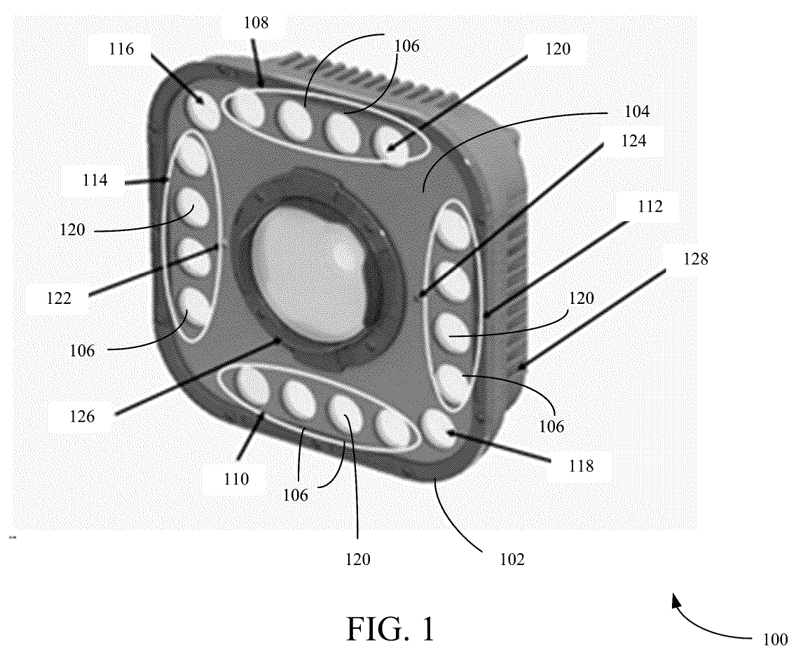

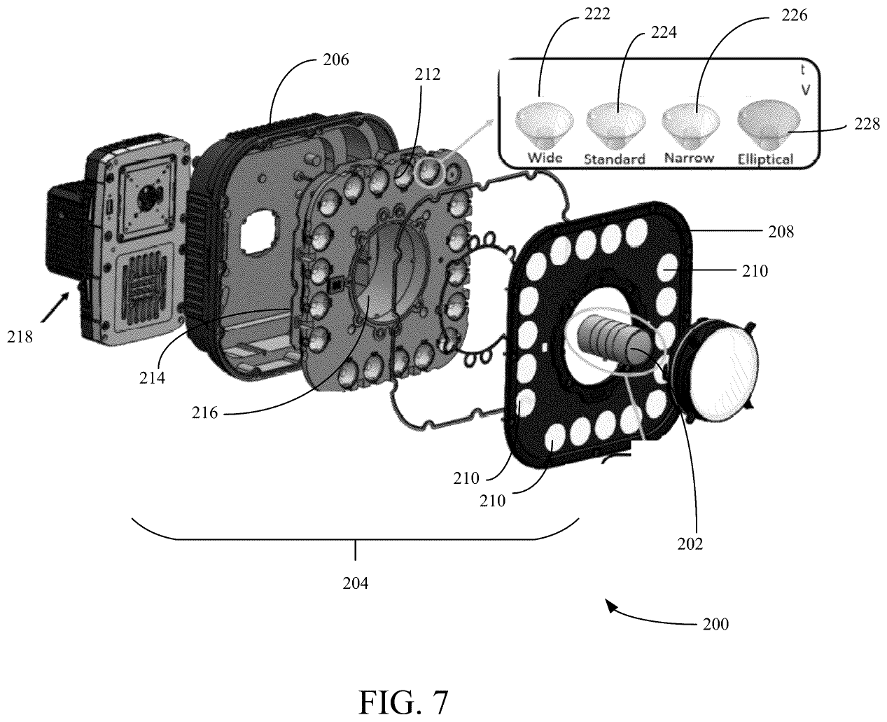

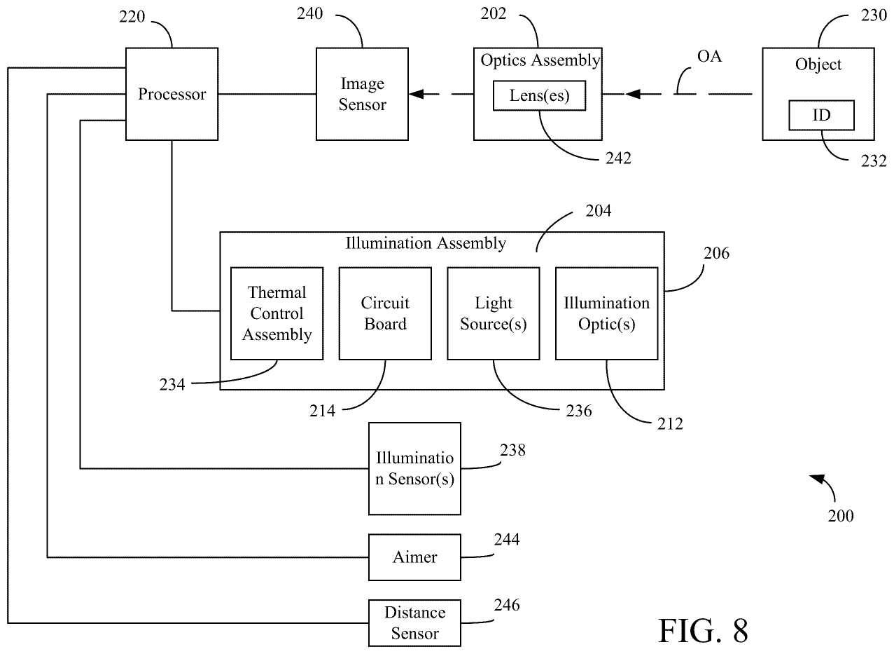

FIG. 1 is a perspective view of an illumination assembly in accordance with an embodiment of the technology. In some embodiments, the illumination assembly 100 may be used in a machine vision system as is discussed further below with respect to FIGS. 7 and 8. The illumination assembly 100 can include a housing 102, a cover 104, and an opening 126 for an imaging optics assembly (e.g., imaging optics assembly 202 shown in FIG. 7). In some embodiments, the opening 126 can have a cylindrical shape and may have electrical connections (not shown) for use with an imaging optics assembly that includes one or more liquid lenses. In some embodiments, when the illumination assembly is incorporated into a machine vision system, the imaging optics assembly opening 126 may allow for access to an imaging optics assembly without requiring the removal of the illumination assembly 100 from the machine visions system. The cover 104 can be configured to be positioned on a front side of the housing 102 and can be attached to the housing 102 using known mechanical attachment mechanisms. The cover 104 can include a plurality of openings 106 for light sources (not shown) and illumination optics 120 (e.g., lens(es), light pipes, etc.). The plurality of light source openings 106 may be disposed on each side of the cover 104 and around the opening 126 for the imaging optics assembly. In some embodiments, the number and arrangement of light source openings 106 can be selected to correspond to certain light sources (not shown) that are disposed in the housing 102. Each light source opening 106 corresponds to a light source. The cover 104 may be exchangeable to provide different numbers and arrangement of light source openings 106. In the example illustrated in FIG. 1, the light source openings 106 are disposed on the cover in four banks and the associated light sources are disposed in banks in the housing. For example, in FIG. 1, the illumination assembly 100 can include a north bank 108 of openings 106 and corresponding light sources, a south bank 110 of openings 106 and corresponding light sources, an east bank 112 of openings 106 and corresponding light sources, and a west bank 114 of openings 106 and corresponding light sources. In some embodiments, the illumination assembly 200 may also include one or more openings 106 for lights configured to address afterglow, for example, first light for afterglow 116 and second light for afterglow light 118. The plurality of light sources of the illumination assembly 100 can be disposed within the housing 102 along with a circuit board, thermal control assembly and illumination optics 120 as discussed further below. As discussed further below, the light sources and illumination optics may be exchanged to provide different configurations including, for example, a monocolor configuration or a multispectral configuration.

In some embodiments, the illumination assembly can also include a thermal control assembly body dissipator 128 that may be used in conjunctions with the thermal control assembly within the housing 102 to dissipate heat generated by, for example, the light sources in the housing 102. In some embodiments, the illumination assembly 100 may also include a distance sensor 122 (e.g., a Time of Flight (TOF) sensor) and an aimer 124 (e.g., a laser aimer). As discussed further below, the distance sensor 122 may be configured to measure distance data, for example, distance to an object (not shown) to be imaged. When the illumination assembly 100 is incorporated into a machine visions system (e.g., as shown in FIGS. 7 and 8), the distance data may be used to determine how to illuminate a scene (e.g., which lights sources and how many light sources to illuminate for imaging an object and to provide a desired emission pattern and opening angle of the light).

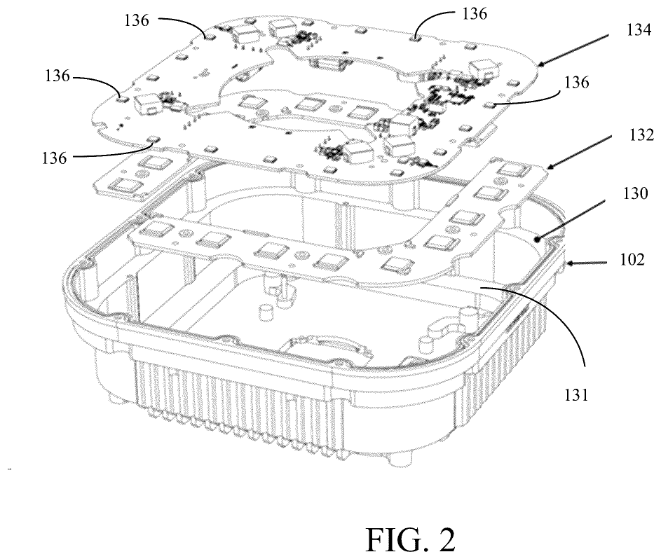

Advantageously, the illumination assembly 100 may be configured as a single mechanical package that can be used for either monocolor light sources or multicolor light sources. As mentioned above, a plurality of light sources of the illumination assembly 100 can be disposed within the housing 102 along with a circuit board, thermal control assembly and illumination optics 120. FIG. 2 is an exploded view of a housing, thermal control assembly and circuit board of the illumination assembly of FIG. 1 in accordance with an embodiment of the technology. Housing 102 is configured to receive and house a thermal control assembly 102 and a circuit board 134. A cover 104 (shown in FIG. 1) and other elements of the illumination assembly 100 are not shown in FIG. 2 for clarity. The thermal control assembly 132 and the circuit board 134 may be positioned on one of a plurality of shelves of the housing 102. For example, the thermal control assembly 132 and the circuit board 134 may be positioned on an upper or first shelf 130 or a lower or second shelf 131. In some embodiments, the thermal control assembly is a heat conductor (e.g., a heat sink). In such embodiments, the heat conductor 132 may be positioned on either the upper shelf 130 or the lower shelf 131 and the circuit board 134 may be positioned on the heat conductor 132 and can be thermally coupled to the heat conductor. While the embodiment shown in FIG. 2 illustrates a heat conductor, it should be understood that other thermal control mechanisms may be implemented. For example, in some embodiments, the thermal control assembly can be implemented as a copper trace (not shown) applied to the edge of the circuit board 134 and the circuit board 134 with the copper trace may be positioned on either the upper shelf 130 or the lower shelf 131.

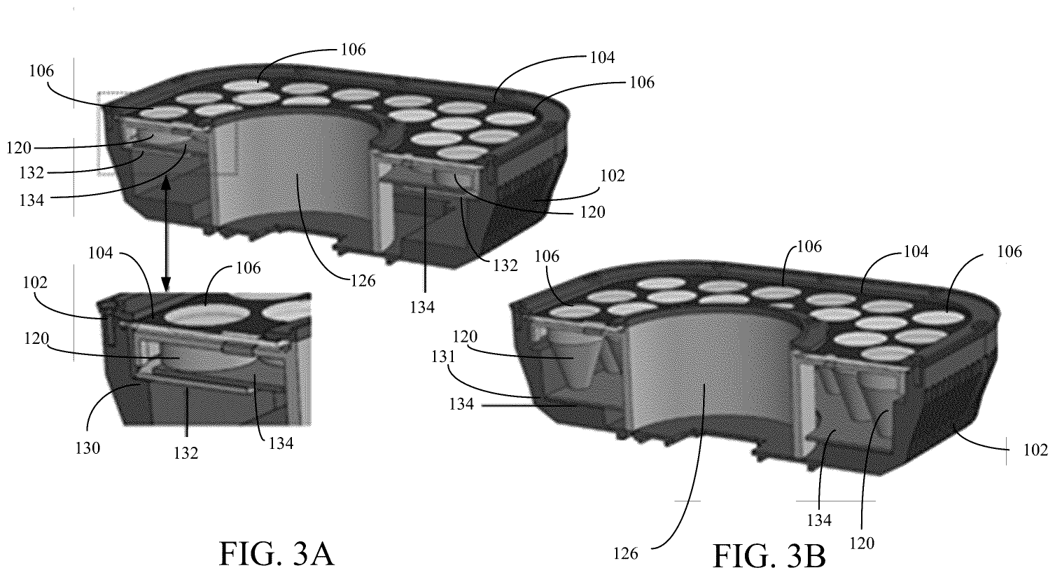

A plurality of light sources 136 may be removably coupled to and positioned on the circuit board 134. In the example illustrated in FIG. 2, eighteen light sources 136 (e.g., LEDs) are shown on the circuit board 134. Known mechanical and electrical attachment mechanisms may be used to removably attach the plurality of light sources 136. In some embodiments, the light sources 136 may be monocolor LEDS. In some embodiments, the light sources 136 may be multispectral LEDs, for example, a RGB LED, an RGBW LED, a RGB(IR) LED, an RGBY LED, an IR and Red LED, a White and Red LED or other RGB or multi-wavelength LED type. The circuit board 134 can be configured to support the plurality of light sources 136 at a predetermined set of positions on the circuit board 134. In some embodiments, the same set of positions on the circuit board 134 may be used for both a configuration with monocolor light sources and for a configuration with multispectral light sources. The housing 102 can include a plurality of shelves that define positions within the housing 102, for example, a first (or upper) shelf 130 and a second (or lower) shelf 131. The plurality of shelves can allow the circuit board 134 and thermal control assembly 130 (e.g., a heat conductor) to be mounted closer to or father away from the cover 104 (shown in FIG. 1) of the illumination assembly 100 to, for example, provide more space for different size illumination optics to be positioned on top of the light sources 136 on the circuit board 134. In some embodiments, each illumination optics can include a lens and the circuit board 134 and thermal control assembly 132 can be positioned on the first shelf 130 in the first position. In some embodiments, each illumination optics can include a light pipe and at least one lens, and the circuit board 134 and the thermal control assembly 132 can be positioned on the second shelf 131 in the second position. As discussed further below with respect to FIG. 3B, in some embodiments the illumination optics for multispectral light sources may include a light pipe and a projection lens. In some embodiments, the illumination optics for monocolor or multispectral light sources may include a light pipe assembly (e.g., a light pipe and a first lens positioned on the light pipe) and a second lens. Accordingly, in some embodiments, the second position can be a lower position in the housing 103 than the first position in order to provide sufficient space for illumination optics assemblies that may have a greater length.

The thermal control assembly 132 is configured to be coupled to the housing 102 and to dissipate heat generated by the plurality of light sources 136 and the circuit board 134 to the housing 102. In some embodiments, the thermal control assembly 132 is a heat conductor configured to dissipate heat generated by the light sources 136 and the circuit board 134. In some embodiments, the thermal control assembly 132 may consist of a copper trace on an outer edge of the circuit board 134 (e.g., a PCB). In some embodiments, other known thermal control assemblies may be used to dissipate heat generated by the plurality of light sources 136 and the circuit board 134 in the illumination assembly 100. Dissipating the heat generated by the light sources, for example, LEDs, and circuit board can be critical for keeping the LED junction temperature low, ensuing as high as possible relative luminous flux.

FIG. 3A is a cross-section view of an illumination assembly in accordance with an embodiment of the technology. The elements of the illumination assembly are shown in an example arrangement in FIG. 3A and it should be understood that different numbers and other arrangements may be used in the illumination assembly in other embodiments. The illumination assembly includes a housing 102, a cover 104 removably connected to the housing 102 and an opening 126 for an imaging optics assembly. As mentioned above, the cover 104 can include a plurality of light source openings 106 in which at least a portion of illumination optics 120 (e.g., a lens) may be positioned and through which light from a corresponding light source (not shown) may pass. The example assembly illustrated in FIG. 3A is configured for monocolor light sources and illumination optics such as lenses. Accordingly, a thermal control assembly 132, for example, a heat conductor, can be positioned on a first or upper shelf 130 in the housing 102 and thermally coupled to the housing 102. A circuit board 134 can be positioned on the heat conductor 132 and can be thermally coupled to the heat conductor 132. A plurality of monocolor light sources (not shown) may be coupled to and positioned on the circuit board so that each light source corresponds to, for example, one of the light source openings 106. Illumination optics 120, for example, a lens, may be positioned over each monocolor light source in the space between the circuit board 134 and the cover 104. In some embodiments, the same type of lens 120 can be used for each monocolor light source. In some embodiments, two or more different types of lenses can be used in the illumination assembly. In some embodiments, the illumination optics 120 may also be removably coupled to the housing 102. Accordingly, the illumination optics 120 may be exchanged. The illumination optics may be selected based on, for example, the image sensor and imaging optics assembly with which the illumination assembly will used in a machine vision system.

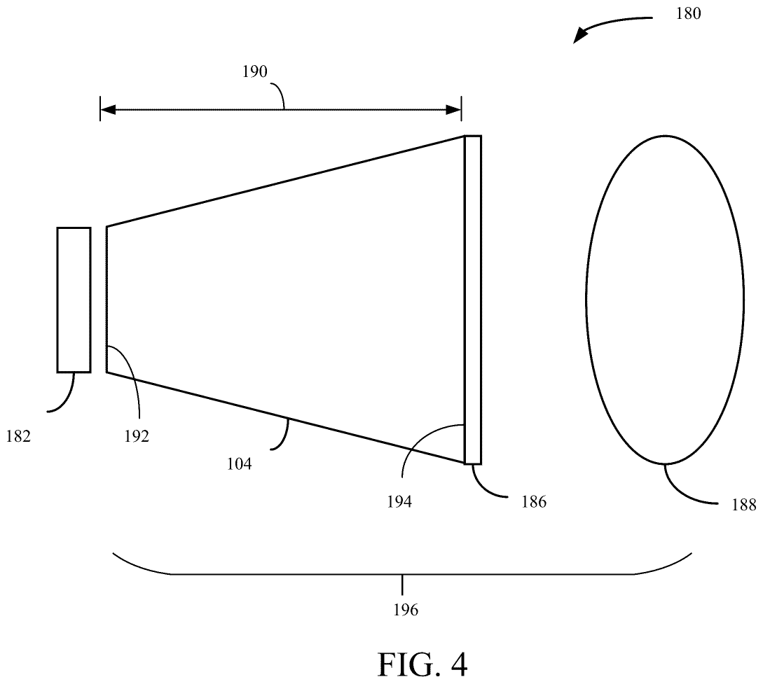

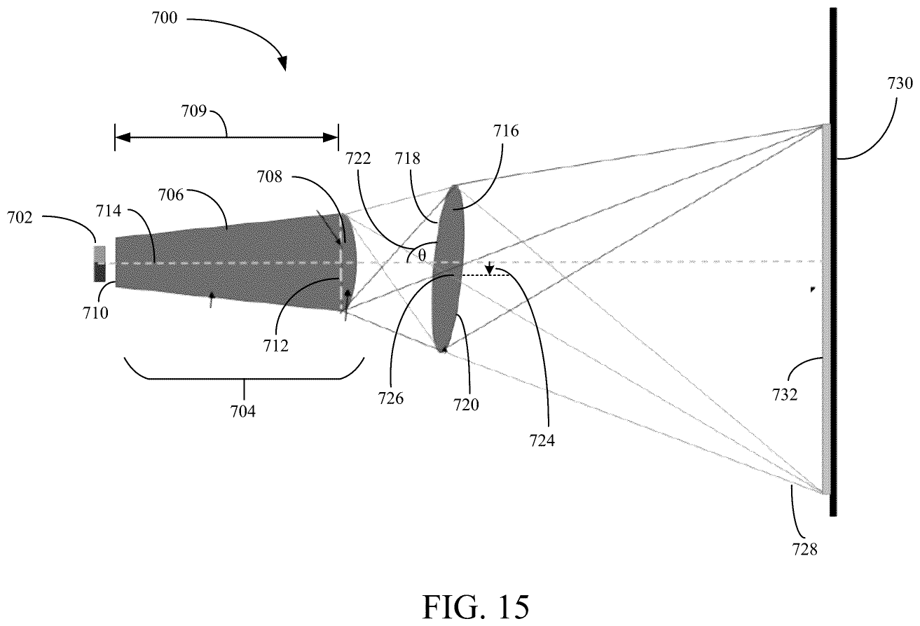

FIG. 3B is a cross-sectional view an illumination assembly in accordance with an embodiment of the technology. The elements of the illumination assembly are shown in an example arrangement in FIG. 3B and it should be understood that different numbers and other arrangements may be used in the illumination assembly in other embodiments. The illumination assembly includes a housing 102, a cover 104 removably connected to the housing 102 and an opening 126 for an imaging optics assembly. The cover 104 can include a plurality of light source openings 106 in which at least a portion of illumination optics (e.g., a lens) may be positioned and through which light from a corresponding light source (not shown) my pass. The example assembly illustrated in FIG. 3B is configured for use with illumination optics with greater length, for example, illumination optics that include a light pipe and at least one lens. Accordingly, the thermal control assembly 132 (not shown) and the circuit board 134 (thermally coupled to the thermal control assembly 312 such as, for example, a heat conductor) can be positioned on a second or lower shelf 131 in the housing 102. A plurality of light sources (not shown), for example, monocolor light sources or multicolor light sources, may be coupled to and positioned on the circuit board 134 so that each light source corresponds to, for example, one of the light source openings 106. In the embodiment illustrated in FIG. 3B, the illumination optics 120 are positioned in front of the corresponding light sources on the circuit board 134 in a space between the circuit board 134 and the cover 104. In some embodiments, the illumination optics 120 for a multispectral light source can include a light pipe and a projection lens. For example, each multispectral light source and its corresponding illumination optics 120 may be a multispectral light assembly as described with respect to FIG. 4. In some embodiments, the illumination optics 120 for a light source (monocolor or multispectral) can include a light pipe assembly (e.g., a light pipe and a first lens positioned on the light pipe) and a second lens. For example, each light source and its corresponding illumination optics 120 can be a light assembly as described with respect to FIGS. 15-17. In some embodiments, the same type of lens for the illumination optics 120 can be used for each light source. In some embodiments, two or more different types of lenses for the illumination optics 120 can be used in the illumination assembly. In some embodiments, the illumination optics 120 (e.g., the lens of the light assembly) may also be removably coupled to the housing 102. Accordingly, the illumination optics 120 may be can be exchanged. As mentioned above, the illumination optics may be selected based on the image sensor and imaging optics assembly with which the illumination assembly will used in a machine vision system.

FIG. 4 is a schematic block diagram of a multispectral light assembly in accordance with an embodiment of the technology. In some embodiments, a plurality of multispectral light assemblies 180 may be used in an illumination assembly, for example, as shown in FIG. 3B. In the embodiment shown in FIG. 4, the multispectral light assembly 180 includes a multispectral light source 182 and beam shaping optics 196 (or secondary optics) that include a light pipe 184 and a projection lens 188. In some embodiments, the beam shaping optics 196 can also optionally include a diffusive surface 186.

Multispectral light source 182 can include a plurality of color LED dies that generate light in multiple wavelengths. In an embodiment, the plurality of color LED dies can be provided in a single package, for example, an RGB LED, an RGBW LED, an RGB(IR) LED, an RGBY LED, other RGB LED type. an IR and Red LED, a White and Red LED, or other multi-wavelength LED type. Each LED die of the multispectral light source may be controlled independently (e.g., using a processor). In some embodiments, the multispectral light source may be an RGBW LED. An RGBW LED may be advantageous for certain applications, for example, for applications such as ID (e.g., barcode) reading when a flashing color of light is not desirable. In addition, the white LED may advantageously be used to increase the number of color channels that may be provided by the multispectral light source 102. For example, a filter may be placed on top of the white LED die of the RGBW LED package to provide the desired additional color. Alternatively, in other embodiments, a multispectral light with the additional desired color LED die may be used, for example, an RGBY LED, an RGB(IR) LED, an RGB(UV) LED, etc.

In the embodiment of FIG. 4, the light pipe 184 is positioned in front of the multispectral light source 182, along an illumination direction, and behind the diffusive surface 186 and the projection lens 188. The light pipe 184 has a length 110, an entrance surface 192 disposed proximate to the multispectral light source 182, and an exit surface 194. In some embodiments, the shape of the light pipe 184 (as illustrated in FIG. 4) may be an inverted truncated pyramid or a similar geometry. In some embodiments, the length 190 of the light pipe 184 and a ratio between the area of the entrance 192 and exit 194 surfaces can be optimized to obtain good color mixing with compact dimensions, including over a relatively short dimension in the illumination direction, as compared to conventional systems. In some embodiments, the geometry or shape of the edges of the light pipe 184 may be optimized. In some embodiments, the entrance 192 and exit 194 surfaces of the light pipe 184 may have a curved geometry. In some embodiments, the shape of the light pipe 184 may be a curved truncated pyramid. In some embodiments, the shape of the light pipe 184 may not follow a particular defined shape, for example, the shape of the light pipe 184 may be a freeform curve.

Generally, the light pipe 184 can be used to collect the maximum amount of light from the multispectral light source 182. In addition, the light pipe 184 can provide a square surface to project the light in a rectangular area and may be used to correct for non-uniformity caused by off-axis placement of the different color dies of the multispectral light source 182. In some embodiments, the light from the light pipe 184 may be projected in areas with other shapes such as a square. Advantageously, the light pipe 184 is configured to provide color mixing including the combination of multiple colors. Light pipe 184 can be used to homogenize the different spectrums generated by the multispectral light source 182 and also to make the mixing of color more uniform. A further advantage of using a light pipe 184 is that the light pipe 184 can enable the projection of direct light (e.g., color mixed) at longer working distances. In some embodiments, the light pipe enables the projection of light in a rectangular area that has a shape that is approximately equal to the field of view (FOV) of a camera of a vision system. As shown in FIG. 4, each multispectral light assembly 180 may include a light pipe 184. Accordingly, in a vision system with a plurality of multispectral light assemblies 180, each multispectral light assembly may include a light pipe 184. In alternative embodiments, a plurality of light pipes may be provided independently, for example, a plurality light pipes may be provided as a separate unitary structure where the light pipes are connected or coupled to each other. The light pipe structure may be removably coupled to a plurality of multispectral light assemblies. For example, an independent light pipe structure may be provided with four light pipes with four connections between the light pipes. In some embodiments, the number of light pipes in the separate, independent light pipe structure may fewer than the number of multispectral light sources in the vision system.

As mentioned above, in some embodiments, the bean shaping optics may optionally include a diffusive surface 186. In some embodiments, the diffusive surface 186 may be, for example, a holographic diffuser positioned on the exit surface 194 of the light pipe 184, a diffusing pattern or texture (e.g., roughness) applied to the exit surface 194 of the light pipe 104, or a micro lenses array (MLA) in the form of foils with adhesive that may be installed on the exit surface 194 of the light pipe 184. For example, in some embodiments, the diffusive surface 186 may be formed by a holographic diffuser that may be attached to the light pipe 184 during a molding process of the light pipe 184 or may be attached to the light pipe 184 after the molding process of the light pipe 184. In another example, the diffusive surface 186 may be formed by a diffusive pattern or texture applied to the exit surface 194 of the light pipe or a diffusive pattern or texture may be formed with the light pipe 184 as one unitary piece. The diffusive surface 186 may be used to control of the shape of a transmitted light beam from the light pipe 184 and to control the angle of the light beam coming out of the light pipe 184. The diffusive surface 106 can be used to make the light pattern at the exit surface 194 of the light pipe 184 more uniform and to provide an optimized balance between uniformity and efficiency between the light pipe 186 and the projection lens 188, with noted improvement in uniformity and efficiency relative to conventional (e.g., Lambertian) diffusers. Accordingly, the diffusive surface 186 can be used to both improve and balance the efficiency and uniformity of the light pattern projected from the light pipe 184. In addition, the light pipe 184 and diffusive surface 186 may be used together to achieve advantageous color mixing properties for the different wavelengths traveling through them, with a very compact size. Advantageously, the diffusive surface 106 may be used to overcome limitations on the length of the light pipe 184, for example, the optimal length of the light pipe 104 may be too large for the overall size constraints of a vision system resulting in the use of a smaller length light pipe. In some embodiments, if there is enough space in the vision system for a light pipe with an optimal length, the exit surface 194 of the light pipe 184 may be clear or transparent without a diffusive surface.

As also shown in the embodiment of FIG. 4, the projection lens 108 may be positioned in front of the light pipe 184 and, if included, the diffusive surface 186. In an embodiment including the diffusive surface 186, the projection lens 188 can finally project the diffusive surface 186 on to the target area. In some embodiments, to further reduce the size of the multispectral light assembly 180 (and the overall size of the vision system) the projection lens 188 may be formed with a high refractive index. In addition, the size of the projection lens 188 may also be minimized by using an aspherical shaped lens. In some embodiments, the projection lens 188 may be a lens with a freeform shaped geometry. Advantageously, a freeform sharped geometry lens can allow for the modification of a light beam in every single point. In some embodiments, different shaped lenses may also be used for the projection lens 188 including, but not limited to, a spherical geometry, a Toroidal geometry, a cylindrical geometry and/or a combination of different geometries in a single lens. As mentioned above, the multispectral light assembly 180 may be configured to generate an illumination area shape that is approximately equal to the FOV of a camera of a vision system that includes the multispectral light assembly 180. For example, the light from the multispectral light assembly 180 may be projected efficiently in a rectangular area that follows the cone of the FOV rather than a random rectangle or round profile. In some embodiments, the light from the multispectral light assembly 180 may be projected in areas with other shapes such as a square.

In an embodiment, the combination the light pipe 184 and an aspherical projection lens 188 can allow for effectively imaging the exit 194 of the light pipe 184 onto the target (e.g., a rectangular illumination area). Advantageously, the combination of the light pipe 184, diffusive surface 186 and projection lens 188 can enable uniform color mixing with compact dimensions of the beam shaping optics 196. In some embodiments, the total track of the multispectral light assembly from the multispectral light source 182 to the vertex of the projection lens 188 may be about 25 mm. In some embodiments, the total track of the multispectral light assembly from the multispectral light source 182 to the vertex of the projection lens may be larger or smaller than 25 mm. In addition, the combination of the light pipe 184, diffusive surface 106 and projection lens 188 can enable a longer working distance and more directed light. In some embodiments, the light distribution and color mixing in the projected illumination area of the multispectral light assembly 180 may be configured for a working distance of 300-1000 mm. In some embodiments, the light distribution and color mixing in the projected illumination area of the multispectral light assembly 180 may be configured for a working distance less than 300 mm or greater than 1000 mm. Accordingly, various embodiments of the multispectral light assembly 180 may advantageously be used for a wide range of different working distances. In some examples, the working distance may be 100-300 mm, 300-500 mm, 800-1000 mm, or 1000-1200 mm. Although the illustrated arrangement of the multispectral light assembly 180 can be advantageous, including for reasons discussed above, other configurations are also possible, including configurations in which one or more of the light pipe 104, the diffusive surface 186, or the projection lens 188 are differently configured, differently arranged, or omitted.

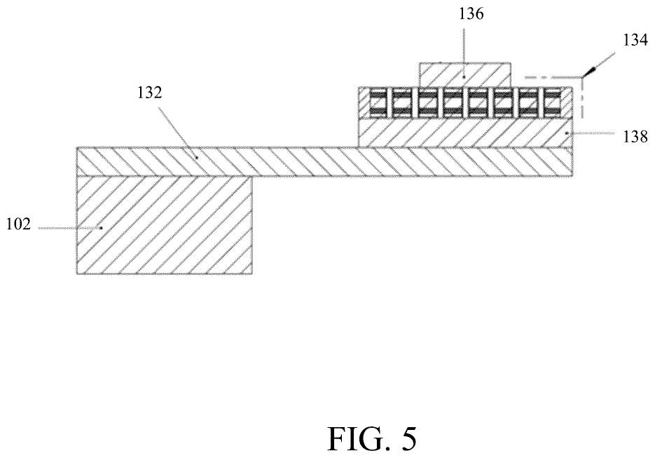

FIG. 5 is a cross-sectional view of a housing, thermal control assembly, control circuit, and light sources of an illumination assembly in accordance with an embodiment of the technology. The elements of the illumination assembly are shown in an example arrangement in FIG. 5 and it should be understood that different numbers and other arrangements may be used in the illumination assembly in other embodiments. The assembly illustrated in FIG. 5 includes a housing 102, a thermal control assembly 132, a circuit board (e.g., a PCB) 134, a light source 136 and a thermal pad 138. In the embodiment illustrated in FIG. 4, the thermal control assembly is a heat conductor 132 and can also include a thermal pad positioned between the heat conductor 132 and the circuit board 134. As mentioned above, the heat conductor 132 may be positioned on a first or second shelf of the housing 102. The heat conductor can also be thermally coupled to the housing 102 to dissipate heat generated by the circuit board 134 and light source 136. Accordingly, heat power of the light source 136 including thermal resistances can be transferred to the housing 102. While only one light source 136 is shown in FIG. 5, as mentioned above, a plurality of light sources 136 may be coupled to the circuit board 134.

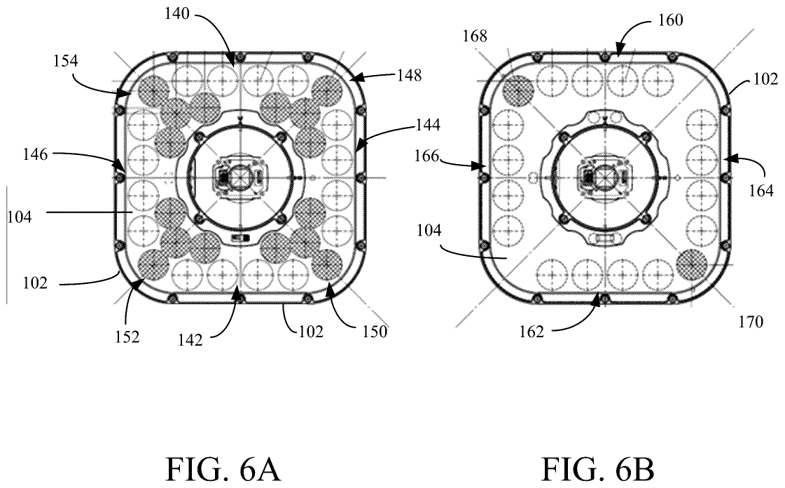

FIG. 6A is a front view of an illumination assembly with an example arrangement of light sources and light source openings in accordance with an embodiment of the technology. The light sources and light source openings of the illumination assembly are shown in an example arrangement in FIG. 6A and it should be understood that different numbers and other arrangements may be used in the illumination assembly in other embodiments. FIG. 6A shows a front view of the housing 102 and cover 104 of an illumination assembly. Each circle in FIG. 6A illustrate a position of a light source and a corresponding light source opening on cover 104. The arrangement shown in FIG. 6A is similar to the arrangement shown in FIG. 3B. A first bank 140 of LEDs (e.g., multispectral LEDs or monocolor (or monochromatic) LEDs) and corresponding light source openings is illustrated on a north side of assembly, a second bank 142 of LEDs (e.g., multispectral LEDs or monocolor LEDs) and corresponding light source openings is illustrated on a south side of assembly, a third bank 144 of LEDs (e.g., multispectral LEDs or monocolor LEDs) and corresponding light source openings is illustrated on an east side of assembly, and a fourth bank 146 of LEDs (e.g., multispectral LEDs or monocolor LEDs) and corresponding light source openings is illustrated on a west side of assembly. In some embodiments, infrared (IR) LEDs may also be utilized in the illumination assembly. In FIG. 6A, a first array 148 of IR LEDS and corresponding light source openings are illustrated on a northeast corner of the assembly, a second array 150 of IR LEDs and corresponding light source openings are illustrated on a southeast corner of the assembly, a third array 152 of IR LEDs and corresponding light source openings are illustrated on a southwest corner of the assembly, and a fourth array 154 of IR LEDs and corresponding light source openings are illustrated on a northwest corner of the assembly. As discussed above, each light source (e.g., LEDs) or combinations of light sources can be turned on and off dynamically, for example, based on a measured distance to an object to be imaged.

FIG. 6B is a front view of an illumination assembly with an example arrangement of light sources and light source openings in accordance with an embodiment of the technology. The light sources and the light source openings of the illumination assembly are shown in an example arrangement in FIG. 6B and it should be understood that different numbers and other arrangements may be used in the illumination assembly in other embodiments. FIG. 6B shows a front view of the housing 102 and cover 104 of an illumination assembly. Each circle in FIG. 6B illustrate a position of a light source and a corresponding light source opening on cover 104. The arrangement shown in FIG. 6B is similar to the arrangement shown in FIG. 1. A first bank 160 of LEDs (e.g., multispectral LEDs or monocolor (or monochromatic) LEDs) and corresponding light source openings is illustrated on a north side of assembly, a second bank 162 of LEDs (e.g., multispectral LEDs or monocolor LEDs) and corresponding light source openings is illustrated on a south side of assembly, a third bank 164 of LEDs (e.g., multispectral LEDs or monocolor LEDs) and corresponding light source openings is illustrated on an east side of assembly, and a fourth bank 166 of LEDs (e.g., multispectral LEDs or monocolor LEDs) and corresponding light source openings is illustrated on a west side of assembly. In some embodiments, the assembly may include one or more lights configured to address afterglow. In FIG. 6B, a first light for afterglow 168 and the corresponding light source opening can be positioned on a northwest corner of the assembly and a second light for afterglow light 170 and the corresponding light source opening can be positioned on a southeast corner of the assembly. As discussed above, each light source (e.g., LEDs) or combinations of light sources can be turned on and off dynamically, for example, based on a measured distance to an object to be imaged.

As mentioned above, the disclosed illumination assembly may be used in a machine vision system. FIG. 7 is an exploded view of a machine vision system including an illumination assembly in accordance with an embodiment of the technology. While FIG. 7 illustrates an embodiment of a vision system arrangement, it should be understood that the various embodiments described herein may be implemented on different types of vision systems including, but not limited to, mobile (e.g., handheld) or fixed mount ID readers, inspection systems, etc. It should be noted that the depicted arrangement of components is illustrative of a wide range of layouts and component types. The illustrated embodiment is thus provided to teach a possible arrangement of components that provide the functions of the illustrative embodiment, although other embodiments can exhibit other configurations.

The machine vision system assembly 200 can be used to acquire, for example, an image of an object (not shown) or an ID on the object. In the illustrated vision system assembly 200 of FIG. 7, an illumination assembly 204 is positioned in front of and, when assembled, coupled to an image sensor assembly 218. The image sensor assembly 218 can include an image sensor (e.g., image sensor 240 shown in FIG. 8) that can be configured to detect one or more wavelengths of light. In some embodiments, the image sensor of the image sensor assembly 218 can be a monochrome sensor (e.g., black and white) or a color sensor. Known mechanical attachment mechanisms may be used to attach the illumination assembly 204 to the image sensor assembly 218.

As discussed above, the illumination assembly 204 can include a housing 206, a cover 208, a plurality of light source openings 210 in the cover 208, a plurality of illumination optics 212, a thermal control assembly (not shown), a circuit board (e.g., a PCB) 214, and a plurality of light sources (not shown). As mentioned above, the plurality of light sources may be positioned on and coupled to the circuit board 214. In some embodiments, the plurality of light sources may be mono-color. In some embodiments, the plurality of light sources may be multispectral. The plurality of light sources, light source openings 210, and illumination optics 212 are shown in an example arrangement in the illumination assembly 204 in FIG. 7 and it should be understood that different numbers and other arrangements of light sources, light source openings 210, and illumination optics 212 may be used in the illumination assembly 204 in other embodiments. The plurality of light sources in the illumination assembly 204 can be used to generate light in one or more wavelengths that may be projected onto an object (not shown) to, for example, acquire an image of the object or an image of an ID on an object. In some embodiments, the plurality of light sources may be positioned symmetrically around an imaging optics assembly 202.

An imaging optics assembly 202 may be positioned in front of the image sensor assembly 218 in an opening 216 of the illumination assembly 204 and, when assembled, coupled to the illumination assembly 204 and the image sensor assembly 218. Known mechanical attachment mechanisms may be used to attach the imaging optics assembly 202 to the illumination assembly 204 and the image sensor assembly 218. When positioned in the opening 216 of the illumination assembly 204, the imaging optics assembly 202 may also be partly surrounded by the illumination assembly 204 as installed for operation. Accordingly, the opening 216 of the illumination assembly 204 may be configured so that at least a portion of the imaging optics assembly 202 can be positioned in the opening 216 when assembled. In some embodiments, parts of the imaging optics assembly 202 can partly protrude into (or even past) the illumination assembly 204. In some embodiments, the opening 216 can include electrical connections (not shown) for used with an imaging optics assembly that includes one or more liquid lenses. Advantageously, the imaging optics assembly 202 can be removed and exchanged without having to remove the illumination assembly 204. The imaging optics assembly 202 and the illumination assembly 204 are shown in an example arrangement in FIG. 7 and it should be understood that different numbers and other arrangements of the imaging optics assembly 202 and the illumination assembly 204 may be used in other embodiments. As discussed above, the imaging optics assembly 202 may project an image's light onto an area of the image sensor of the image sensor assembly 218 and, correspondingly, define a FOV for imaging with the image sensor of the image sensor assembly 218. In some embodiments, the imaging optics assembly 202 can include one or more lenses such as, for example, a high-speed liquid lens, to allow for rapid and automated adjustment of focus for images at different working distances. In other embodiments, the imaging optics assembly 202 can include one more solid (e.g., glass) lenses.

As mentioned, the illumination assembly 204 can include a cover 208 with a plurality of light source openings 210, and a plurality of illumination optics (or illumination optics assemblies) 212. The illumination optics may be for example, lenses. In some embodiments with multispectral light sources, the illumination optics can include a light pipe and projection lens for each multispectral light source. In some embodiments, with wither monocolor or multispectral light sources, the illumination optics can include a light pipe assembly (e.g., a light pipe and a lens positioned on the light pipe) and a second lens. Illustrated in FIG. 7 are examples of different types of lenses that may be used in a monochromatic embodiment of the illumination assembly 204 as illumination optics 212 (without a light pipe) such as a wide lens 222, a standard lens 224, a narrow lens 226 and an elliptical lens 228. In some embodiments, the lenses may be selected to provide a desired emission pattern. In some embodiments, the same type of lens can be used for each light source. In some embodiments, two or more different types of lenses can be used in the illumination assembly 204. The vision system assembly 200 may also include other elements that are not shown in FIG. 7 for clarity. For example, the vision system assembly 200 may also include processing components (e.g., a processor 220 shown in FIG. 8) that perform various vision system tasks such as ID code finding and decoding, inspection, etc.

FIG. 8 is a schematic block diagram of vision system 200 with an illumination assembly in accordance with an embodiment of the technology. While FIG. 8 illustrates an embodiment of a vision system arrangement, it should be understood that the various embodiments described herein may be implemented on different types of vision systems including, but not limited to, mobile (e.g., handheld) or fixed mount ID readers, inspection systems, etc. It should be noted that the depicted arrangement of components is illustrative of a wide range of layouts and component types. The illustrated embodiment is thus provided to teach a possible arrangement of components that provide the functions of the illustrative embodiment, although other embodiments can exhibit other configurations.

The machine vision system 200 shown in FIG. 8 includes an illumination assembly 204, an image sensor 240 (e.g., included in image sensor assembly 218 shown in FIG. 7) and an imaging optics assembly 202. The vision system 200 can be used to acquire an image of, for example, an object 230, an exemplary ID (e.g., a symbol, a barcode) 232 on the object 230, or to acquire an image to detect the presence or absence of the object 230. The vision system 200 also includes processing components (e.g., processor 220) that perform various vision system tasks such as ID code finding and decoding, inspection, etc. In some embodiments, the processing components may be included in an image sensor assembly 218 such as, for example, image sensor assembly 218 shown in FIG. 7. In some embodiments, processing components may also be included in one or more of the imaging optics assembly 202 and the illumination assembly 204. As discussed above with respect to FIGS. 1-6B, the illumination assembly 204 may include a housing 206, a thermal control assembly 234 (e.g., a heat conductor), a circuit board (e.g., a PCB) 214, a plurality of light sources 236, and illumination optics 212.

In some embodiments, the illumination assembly 204 may be positioned in front of and, when assembled, coupled to the imaging optics assembly 202. As described above relative to FIGS. 1-6B, the plurality of light sources 236 may be monocolor light sources or multispectral light sources. In some embodiments, the plurality of light sources 236 may be LEDs. The plurality of light sources 236 may be used to generate light in one or more wavelengths that may be projected onto the object 230 to, for example, acquire an image of the object 230 or an image or the ID 232 on the object. As discussed further below, in some embodiments utilizing multispectral light sources, different wavelengths (i.e., color channels) can be activated sequentially or according to other control strategies.

In some embodiments, the plurality of light sources 236 may be positioned symmetrically around the camera lens (e.g., lens(es) 242 of the imaging optics assembly 202). For example, light sources or banks of light sources can be distributed at regular intervals around a lens or in a balanced configuration on multiple sides of a lens. The illumination assembly 204 may advantageously be used to project light into a well-defined and uniformly illuminated area on the object 210, for example, an illuminated area that has a shape that is approximately equal to the field of view (FOV) of the vision system 200. In some embodiments, the illuminated area may be a rectangular area. In some embodiments, the illuminated area may have other shapes such as a square.

As mentioned, the vision system 200 can be used to acquire an image of the object 230 or the exemplary ID 232, for example, in the form of a barcode, on the object 230. An image may be acquired by projecting an illumination light on the object 230 and receiving reflected illumination light from the object 230. Thus, in front of the image sensor 240 can be placed an imaging optics assembly 202 having a series of lenses 242 that project the images light onto the area of the image sensor 240 and, correspondingly, define a FOV for imaging with the image sensor 240. In an embodiment, the imaging optics assembly 202 may include a lens assembly 242 with one or more liquid lenses, as may allow for rapid and automated adjustment of focus for images at different working distances. In other embodiments, the imaging optics assembly 202 can include a lens assembly 242 with mechanical parts (e.g., gear, motor and thread assembly) that are used to move a lens toward or away from the image sensor 240 to change the focal distance of the system 200. Light projected from the illumination assembly 204 that is reflected from the object 230 back to the vision system 200 is directed through the lens(es) 242 along a reader optical axis OA to the image sensor 240. The image sensor 240 can be configured to detect different wavelengths of light. In some embodiments, the image sensor 240 may be monochromatic sensor (e.g., black and white) or a color sensor. The reflected light is received by the image sensor 240 for processing (e.g., by processor 220) to, for example, generate an image of the subject. Known methods may be used for generating an image of the scene and decoding data therein.

The processor 220 can control vision system analysis processes (e.g., ID reading and decoding, inspection) as well as other functions, including projection of an aimer beam, illumination for image acquisition (e.g., timing or intensity of illumination, selection of a light source for illumination, etc.), automatic focus adjustment, etc. In some embodiments, the processor 202 can include one or more processor devices that can be provided on one or more circuit boards and operatively interconnected by the appropriate ribbon cable(s) or other communication channels (not shown). The system 200 may also be configured to wirelessly transmit (via a wireless link, not shown) decoded data to a data handling device such as an inventory tracking computer or logistics application. Alternatively, the system 200 may be wired to a data handling device/network or can store and subsequently transfer collected information when it is connected to a base unit. The processor 220 may be in communication with the image sensor 240, the illumination assembly 204, an illumination sensor 238, an aimer 244, a distance sensor 246, as well as a variety of other components (not shown), such as motors for an adjustment of system orientation, or a variety of other actuators. While one processor 220 is shown in FIG. 8 in communication with the image sensor 240 and the illumination assembly 204, in some embodiments, a separate processor may be provided for each of the image sensor 240 and the illumination assembly 204. For example, as mentioned above, processing components can be included in an image sensor assembly 218 (referred to herein as an image sensor assembly processor)) and the illumination assembly 204 (referred to herein as an illumination assembly processor).

In some embodiments, the vision system 200 also includes an integrated (e.g., internal) illumination sensor 238 that is in communication with the processor 220 or a processor included in the illumination assembly 204, for example, a processor located at a PCB level of the illumination assembly 204 (e.g., circuit board 134 shown in FIG. 2) The illumination sensor 238 may be located, for example, proximate to the plurality of light sources 236 of the illuminations assembly 204. In an embodiment, the illumination sensor 238 may be integrated into the illumination assembly 204. For an embodiment of the illumination assembly 204 where the plurality of light sources 236 are multispectral light sources, the illumination sensor 238 and the processor 220 (and/or a processor included in the illumination assembly 204) can implement a feedback loop that may be used to control the amount of light of the different color channels projected by the illumination assembly 204 and thereby improve image acquisition. In some embodiments, the illumination sensor 238 may advantageously be located proximate to or near the multispectral LEDs in the vision system 200. For example, the illumination sensor 238 may be located at a PCB level of the illumination assembly 204, for example, circuit board 134 shown in FIG. 2, and collect light from the LEDs of the plurality of light sources 236. In some embodiments, a plurality of illumination sensors 238 may be located higher in the structure of the vision system 200, for example, proximate to or near the lenses (e.g., the illumination optics 212) of each light source 236 and a far end of the vision system 200. In this embodiment, it is advantageous to include a plurality of illumination sensors 238 because it may be possible that not all of the subsystems of the vision system 200 may perform with the same efficiency. The illumination sensors 238 can be coupled to the PCB of the illumination assembly 204 and located at a particular height.

For example, as also discussed further below, part of the light transmitted through one or more of the multispectral light sources 236 can be diverted onto, or otherwise received by, the illumination sensor 238, which can then measure the intensity of the light. As appropriate, the measured intensity can be used to control the amount of light (intensity and/or LED on-time) for each of the wavelengths (a.k.a. color channels). Advantageously, in some embodiments, each wavelength or color channel is activated sequentially so that only one channel is on (i.e., illuminating a target for imaging) at any time. Accordingly, the illumination sensor 238 only needs to measure one color channel at a time and the illumination sensor 238 may be, for example, a single photo-diode that may be used to measure each of the colors. As each color channel is on, the intensity or an exposure time can be adjusted until a target amount of light or exposure (i.e., the product of the intensity and exposure duration (or exposure time or LED on-time)) is reached. Once the target exposure (or amount of light) is reached for a particular color channel, the channel can be turned off, and the next color channel can be turned on (as appropriate). In an embodiment, the feedback loop and exposure adjustment may be repeated for each color channel as each channel is sequentially activated.

In some embodiments where the light sources 236 are multispectral, each wavelength or color channel may be activated simultaneously so that all channels are on (i.e., illuminating a target for imaging) at the same time. Accordingly, in some embodiments, the illumination sensor 238 may include a plurality of illumination sensors and each illumination sensor may be configured to measure one of the color channels. For example, each illumination sensor 238 may be, for example, a photodiode configured to measure one of the colors. In some embodiments, for simultaneous illumination with a plurality of colors channels, the illumination sensor 238 may be a single illumination sensor 238 (e.g., a photodiode) configured to measure all of the color channels simultaneously. In some embodiments with simultaneous activation of each wavelength or color channel, color mixing may be performed and colors beyond those installed on a system (e.g., the system shown in FIG. 2) may be measured. As mentioned above, the intensity or an exposure time of each color channel can be adjusted until a target amount of light or exposure (i.e., the product of the intensity and exposure duration (or exposure time or LED on-time)) is reached. Once the target exposure (or amount of light) is reached for a particular color channel, the channel can be turned off.

In some embodiments, the system 200 may also include an aimer 244 (e.g., aimer 124 shown in FIG. 1). To ensure that the ID 232 (e.g., a barcode) is properly imaged, the ID 232 may be required to be properly oriented relative to the system 200 (e.g., centered or fully within a field of view of the system 200), for example, if system 200 is implemented as a handheld system. The aimer 244 can be used to project an aimer pattern that may be directed by a user of system 200 onto ID 232. This can help ensure that the ID 232 resides fully within the field of view for image acquisition. In some embodiments, the light beam projected by the aimer 244 to generate the aimer pattern may be substantially coaxial (on-axis) with a reader optical axis OA.

In some embodiments, the system 200 can include a distance sensor 246 (e.g., distance sensor 122 shown in FIG. 1) which may be configured to measure and provide distance data, for example, distance data regarding the object 230 (e.g., distance to the object 230) to be imaged by the vision system 200. In some embodiments, the distance sensor may be, for example, a Time of Flight (TOF) sensor or system or other type of distance sensor. The distance sensor 246 may be configured to provide distance data to the processor 220. In some embodiments, the processor 220 can be configured to use known methods to determine, for example, a working distance between the object 230 and the imaging optics assembly 202 based on the distance data acquired by the distance sensor 246. In some embodiments, the processor 220 may be configured to determine a working distance between the object 230 and the imaging optics assembly 202 using other known techniques such as, for example, image analysis. In some embodiments, various constraints of the particular vision system application may be considered when determining the working distance to the object including, for example, a speed of the object on a conveyor, a curvature of the object, a size of the target (e.g., ID 232) on the object, etc. In some embodiments, the measured working distance can be used to determine how to illuminate a scene. For example, different light sources 236 and combinations of light sources 236 in the illumination assembly 204 may be selectively illuminated based on the measured distance to provide a desired emission pattern and/or FOV to acquire an image at the measured distance. As mentioned above, advantageously, the physical position and orientation of the light sources does not need to be changed to generate different illumination configurations using the plurality of light sources 236 and the corresponding illumination optics 212.

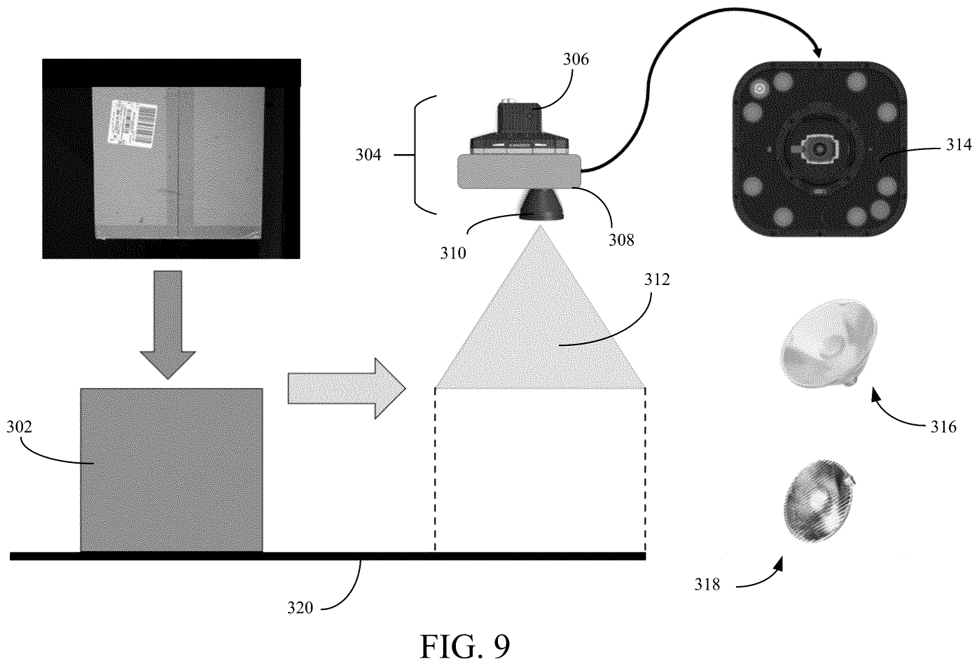

FIG. 9 illustrates an example illumination pattern of light sources and example illumination optics for a wide field of view in accordance with an embodiment of the technology. As described above, an image of an object 302 (or an ID on the object) can be acquired using a machine vision system 304 (e.g., machine vision system 200 shown in FIGS. 7 and 8). In some embodiments, the object 302 may be positioned on a conveyor 320 and the machine vision system 304 can be positioned above the conveyor. The machine vision system 304 can include an image sensor assembly 306, an illumination assembly 308 (e.g., an illumination assembly as described above with respect to FIGS. 1-8), and an imaging optics assembly 310. In this embodiment, the illumination assembly 308 may be a monochromatic embodiment of the illumination assembly. In FIG. 9, a wide angle FOV 312 may be provided for a closer working distance to object 302 using the example illumination pattern 314 (i.e., the selected light sources from the plurality of light sources in the illumination assembly 308 that are turned on) to generate illumination for the object 302. Two example lenses 316, 318 are shown that may be used as the illumination optics corresponding to the light sources in a monochromatic embodiment of the illumination assembly 308 to provide the wide FOV 312.

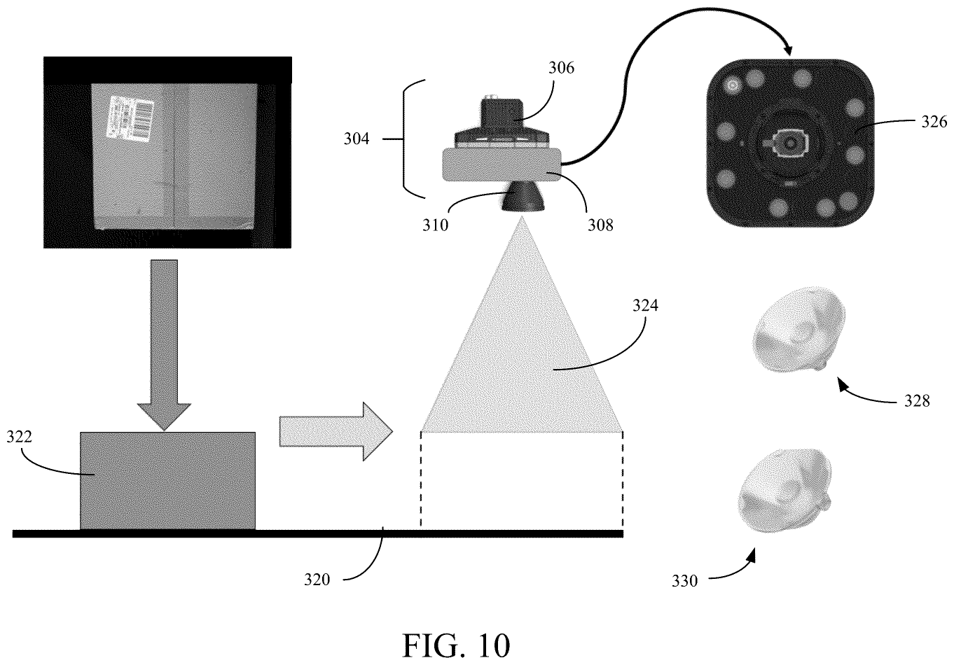

FIG. 10 illustrates an example illumination pattern of light sources and example illumination optics for an intermediate field of view in accordance with an embodiment of the technology. An image of an object 322 (or an ID on the object) can be acquired using a machine vision system 304 (e.g., machine vision system 200 shown in FIGS. 7 and 8). In some embodiments, the object 322 may be positioned on a conveyor 320 and the machine vision system 304 can be positioned above the conveyor 320. The machine vision system 304 can include an image sensor assembly 306, an illumination assembly 308 (e.g., an illumination assembly as described above with respect to FIGS. 1-8), and an imaging optics assembly 310. In this embodiment, the illumination assembly 308 is a monochromatic embodiment of the illumination assembly. In FIG. 10, an intermediate FOV 324 may be provided for a medium working distance to object 302 using the example illumination pattern 326 (i.e., the selected light sources from the plurality of light sources in the illumination assembly 308 that are turned on) to generate illumination for the object 302. Two example lenses 328, 330 are shown that may be used as the illumination optics corresponding to the light sources in a monochromatic embodiment of the illumination assembly 308 to provide the intermediate FOV 324.

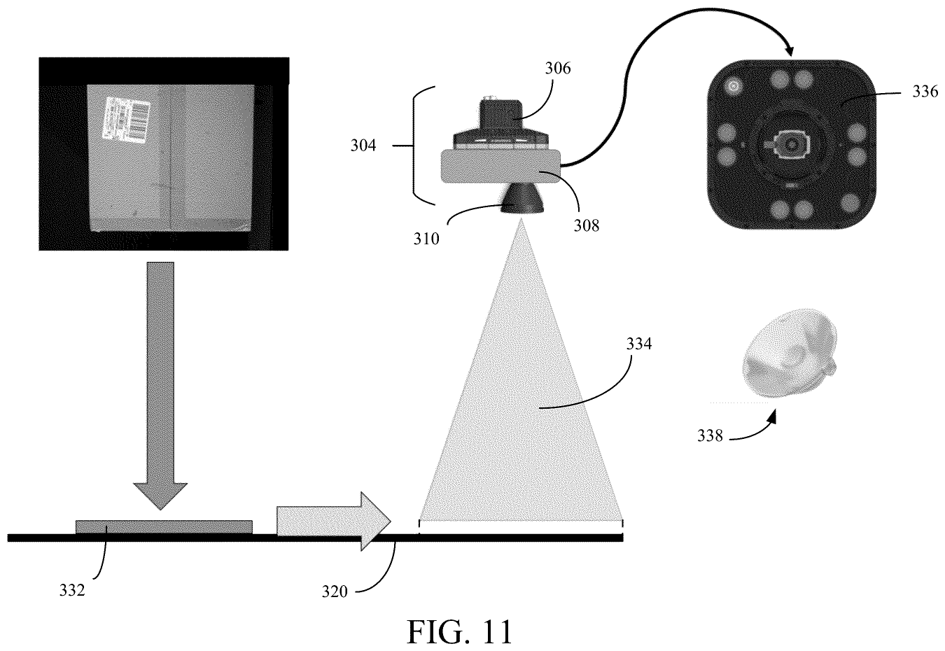

FIG. 11 illustrates an example illumination pattern of light sources and example illumination optics for a narrow field of view in accordance with an embodiment of the technology. An image of an object 332 (or an ID on the object) can be acquired using a machine vision system 304 (e.g., machine vision system 200 shown in FIGS. 7 and 8). In some embodiments, the object 332 may be positioned on a conveyor 320 and the machine vision system 304 can be positioned above the conveyor 320. The machine vision system 304 can include an image sensor assembly 306, an illumination assembly 308 (e.g., an illumination assembly as described above with respect to FIGS. 1-8), and an imaging optics assembly 310. In this embodiment, the illumination assembly 308 may be a monochromatic embodiment of the illumination assembly. In FIG. 11, a narrow FOV 334 may be provided for a long working distance to object 302 using the example illumination pattern 336 (i.e., the selected light sources from the plurality of light sources in the illumination assembly 308 that are turned on) to generate illumination for the object 302. An example lens 338 is shown that may be used as the illumination optics corresponding to the light sources in a monochromatic embodiment of the illumination assembly 308 to provide the narrow FOV 334.

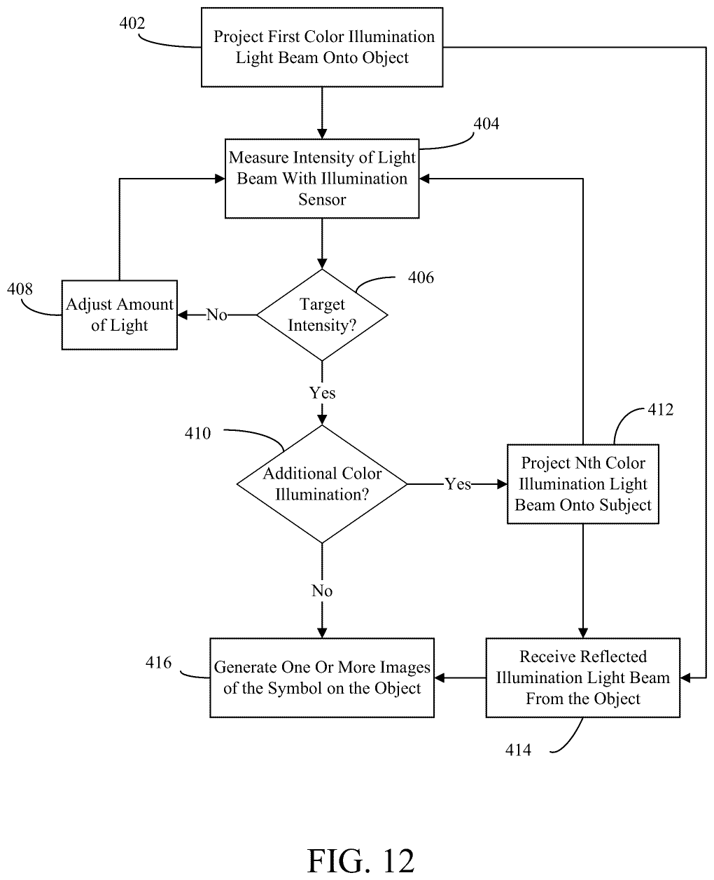

FIG. 12 illustrates a method for controlling an illumination assembly with multispectral light sources for generating an image in accordance with an embodiment of the technology. As mentioned above with respect to FIG. 8, the amount of light from the different color channels generated by the multispectral light sources in the illumination assembly may be controlled using an illumination sensor (e.g., illumination sensor 238 shown in FIG. 8) and a processor (e.g., processor 220 shown in FIG. 8 and/or, in some embodiments, a processor included in the illumination assembly 204) to form a feedback loop. In some embodiments, the color channels are advantageously activated sequentially. For example, a separate exposure may be used for each sequentially activated color channel, or each color channel can be activated sequentially during the same single exposure.

In one example, at block 402, a first color illumination light beam is projected onto an object by activating, for example, a corresponding color LED die of one or more multispectral light sources (e.g., a multispectral light source of a multispectral light assembly 180 shown in FIG. 4). In some embodiments, the light beam may be a single color (e.g., may be generated by only LEDs of a single color). At block 404, the intensity of the generated color illumination light beam is measured using an illumination sensor (e.g., illumination sensor 238 shown in FIG. 8). For example, part of the color illumination light transmitted from one more multispectral light assemblies can be diverted onto the illumination sensor that then measures the intensity of the light. In some embodiments, the illumination sensor may be a photo-diode, which may not be particularly tuned to any given color of light.

At block 406, it is determined (e.g., by a processor device) whether the measured intensity is sufficient, e.g., whether the measured intensity generates a target exposure or amount of light (i.e., the product of the measured intensity and the exposure time) or whether the integrated intensity for the color over a particular time (e.g., within the current exposure) is sufficient. If the measured intensity at block 404 is not sufficient to generate the target exposure, the amount of light (e.g., intensity or duration of illumination of the color LED die(s)) is adjusted at block 408. Or, if the total intensity over time is not sufficient, a length of an exposure for that color of light may be adjusted (e.g., extended). In some embodiments, the intensity of the light beam will continue to be measured, and corresponding adjustments made, until the intensity is sufficient (e.g., the current intensity or the intensity over time generates the target exposure (or amount of light)).

In some embodiments, as also noted above, adjusting an amount of light (e.g., at block 408) can include adjusting a duration of an amount of time during which a particular color of light is used to illuminate a target. For example, during an image acquisition over a single or multiple exposures, the duration of illumination for any given color of light from a multispectral illumination assembly can be determined in real time (or otherwise) by monitoring the cumulative illumination provided by that color of light and determining when the cumulative illumination is sufficient for good image acquisition.

Once the intensity of the color illumination light beam reaches the target intensity (or target exposure) at block 406, it is determined whether there are any additional color illuminations (e.g., color channels) that need to be projected on the object at block 410. The specific color channels that are projected on the object may be determined, for example, based on the specific application of the vision system. If there is an additional color illumination at block 410, the first color illumination light beam can be turned off and a second color illumination light beam (or color channel) is projected in the object at block 412 and the process move to block 404. At block 404, the intensity of the second generated color illumination light beam is measured using the illumination sensor (e.g., illumination sensor 238 shown in FIG. 8). The amount of light from second color illumination light beam is then adjusted at block 408 until it reaches the target intensity (or target exposure) at block 410.

Blocks 404-412 can be repeated, as appropriate, for each color illumination light beam, for example for N color illumination light beams, until all of the color channels have been projected at the target intensity (or target exposure). As mentioned above, the color channels may sometimes thus be activated sequentially, and in some cases a prior color channel can be turned off before the next color channel is turned on.

As the various color illumination light beams (or color channels) are projected on the object, the illumination light reflected from the object is received by the vision system and, for example, directed to an image sensor by one or more lenses at block 414 (e.g., image sensor 240 and lens(es) 242 shown in FIG. 8). Once all of the necessary color illumination light beams (or color channels) have been projected at block 410, one or more images of the object or a symbol on the object may be generated based on the received illumination light using a processor (e.g., processor 220 shown in FIG. 8) at block 416. Known methods may be used for generating an image of the object or a symbol on the object and deciding data therein. For example, a single image can be generated based on a single exposure, during which different colors of light illuminate an object at different times, or a single image can be generated as a composite of multiple exposures, during which different colors of light are used.

As mentioned above, it may be advantageous to activate each color channel sequentially so that only one channel is on at any time. Accordingly, in some embodiments, the illumination sensor only needs to measure one color channel at a time and the illumination sensor may be, for example, a single photo-diode that may be used to measure each of the color channels.

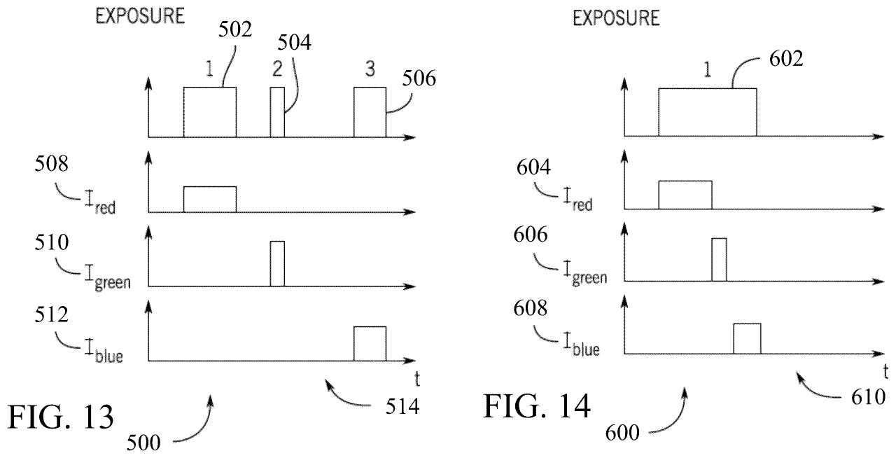

As mentioned above, in some embodiments a separate exposure may be used for each sequentially activated color channel. FIG. 13 is a graph illustrating a timing configuration using multiple exposures for generating an image using an illumination assembly with multispectral light sources in accordance with an embodiment of the technology. The example timing configuration 500 includes three separate exposures, namely, a first exposure 502, a second exposure 504 and a third exposure 506 that occur sequentially over time as illustrated by axis 514. A first color channel 508 (e.g., red) may be activated and may be used to generate illumination light during the first exposure 502. At the completion of the first exposure 502, the first color channel 508 may be turned off and a second color channel 510 (e.g., green) may be activated and may be used to generate illumination light during the second exposure 504. At the completion of the second exposure 504, the second color channel 510 may be turned off and a third color channel 512 (e.g., blue) may be activated and may be used to generate illumination light during the third exposure 506. Each exposure may be used to generate a monochromatic image. The monochromatic images from the three different color channels may then be merged to create a full RGB (or other) image. Known methods may be used for creating a full RGB image from a plurality of monochromatic images. In some embodiments, the duration of the exposures 502, 504, 506 can be determined according to the method illustrated in FIG. 12, or as otherwise generally discussed above.

In some embodiments, each color channel can be activated sequentially during the same exposure. FIG. 14 is a graph illustrating a timing configuration using a single exposure for generating an image using an illumination assembly with multispectral light sources in accordance with an embodiment of the technology. The example timing configuration 600 includes a single exposure 602. Each color channel may be activated sequentially over time during the exposure 602 as illustrated by axis 610. A first color channel 604 (e.g., red) may be activated at a first time point and may be used to generate illumination light during the exposure 602. At the completion of a particular time period for activation of the first color channel 604, the first color channel 604 may be turned off and a second color channel 606 (e.g., green) may be activated at a second time point and may be used to generate illumination light during the exposure 602. At the completion of a particular time period for activation of the second color channel 606, the second color channel 606 may be turned off and a third color channel 608 (e.g., blue) may be activated at a third time point and may be used to generate illumination light during the exposure 602. The third color channel 608 may be activated for a particular period of time and then turned off. Thus, the three color channels 604, 606 and 610 may be mixed during the exposure 602 without actually overlapping in time. As described above with respect to FIG. 12, an illumination sensor and feedback loop may be used to control the intensity and/or the on-time of each channel 604, 606, 608 (i.e., the width of the pulses for each color channel along the axis 610) to achieve the correct color mix. Accordingly, the color mixing may be controlled during a single exposure time of the camera of the vision system. The single exposure may be used to generate a monochrome image according to any variety of known methods. However, the monochrome image may advantageously have optimized contrast for one or more of the associated colors. Further, because a single exposure can be faster than multiple separate exposures, while providing a comparable cumulative lighting intensity, the timing configuration of FIG. 14 may be advantageous for sorting applications that involve moving objects.

As mentioned above, in some embodiments, each wavelength or color channel may be activated simultaneously so that multiple channels are on (i.e., illuminating a target for imaging) at the same time. Accordingly, in some embodiments, the illuminations sensor may include a plurality of illumination sensors and each illumination sensor may be configured to measure one of the color channels. For example, each illumination sensor may be, for example, a photodiode configured to measure one of the colors. In some embodiments, for simultaneous illumination with a plurality of colors channels, the illumination sensor may be a single illumination sensor (e.g., a photodiode) configured to measure all of the color channels simultaneously. As mentioned above, the intensity or an exposure time of each color channel can be adjusted until a target amount of light or exposure (i.e., the product of the intensity and exposure duration (or exposure time or LED on-time)) is reached. Once the target exposure (or amount of light) is reached for a particular color channel, the channel can be turned off.

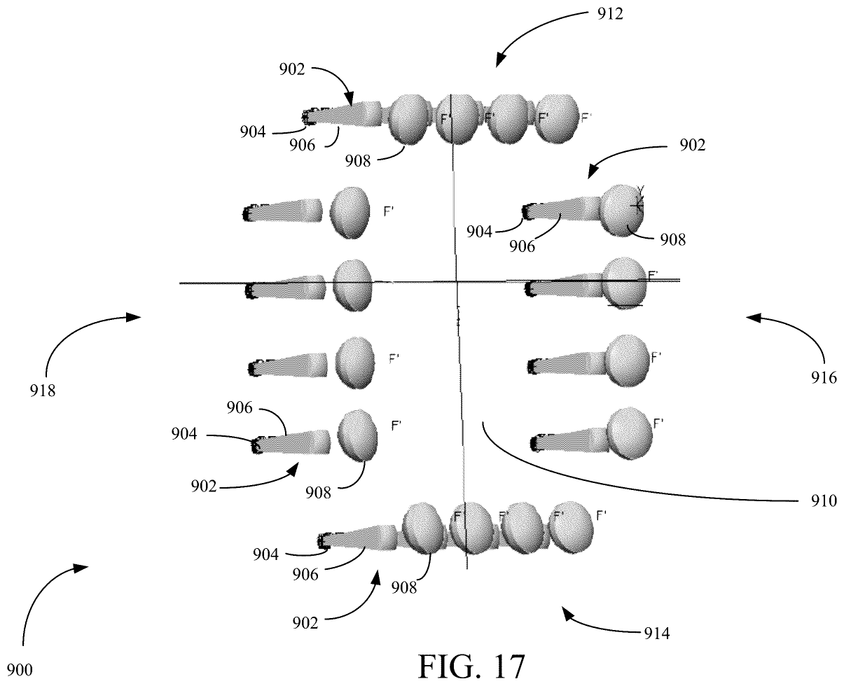

As discussed above with respect to FIGS. 1-8, in some embodiments an illumination assembly can include a plurality of light assemblies, where each light assembly includes a light source (monocolor or multispectral) and an illumination optics assembly (or illumination optics) that includes a light pipe assembly (e.g., a light pipe and a first lens positioned on the light pipe) and a second lens. FIG. 15 is a schematic diagram of an example light assembly in accordance with an embodiment of the technology. In some embodiments, a plurality of light assemblies 700 may be used in an illumination assembly, for example, as shown in FIGS. 1 and 3B and as discussed below with respect to FIG. 17. In the embodiments shown in FIG. 15, the light assembly 900 includes a light source 702 and a two element illumination optics assembly that includes a light pipe assembly 704 and a second lens 716. In some embodiments, the light source 702 can be a monocolor or a multispectral light source. The light pipe assembly 704 can include a light pipe 706 (or light guide, or mixing rod) and a first lens 708.

As mentioned, in some embodiments, the light source 702 can be a multispectral light source. A multispectral light source can include a plurality of color LED dies that generate light in multiple wavelengths. In an embodiment, the plurality of color LED dies can be provided in a single package, for example, an RGB LED, an RGBW LED, an RGB(IR) LED, an RGBY LED, other RGB LED type. an IR and Red LED, a White and Red LED, or other multi-wavelength LED type. Each LED die of a multispectral light source may be controlled independently (e.g., using a processor). In some embodiments, the multispectral light source may be an RGBW LED. An RGBW LED may be advantageous for certain applications, for example, for applications such as ID (e.g., barcode) reading when a flashing color of light is not desirable. In addition, the white LED may advantageously be used to increase the number of color channels that may be provided by the multispectral light source 102. For example, a filter may be placed on top of the white LED die of the RGBW LED package to provide the desired additional color. Alternatively, in other embodiments, a multispectral light with the additional desired color LED die may be used, for example, an RGBY LED, an RGB(IR) LED, an RGB(UV) LED, etc.

The light pipe 706 can have a length 709, an entrance surface 710, an exit surface 712, and an optical axis 714. In the embodiment of FIG. 15, the light pipe 704 is positioned in front of the light source 702, along the optical axis (e.g., an illumination direction), such that the entrance surface 710 of the light pipe 706 is disposed proximate and parallel to the light source 702 and the optical axis 714 of the light pipe 706 is centered on the light source 702. In some embodiments, the shape of the light pipe 706 (as illustrated in FIG. 15) may be an inverted truncated pyramid or a similar geometry. In some embodiments where the light source 702 is a multispectral light source, the length 709 of the light pipe 706 and a ratio between the area of the entrance 710 and exit 712 surfaces can be optimized to obtain good color mixing (e.g., for two or more wavelengths of light from the light source 702) with compact dimensions, including over a relatively short dimension in the illumination direction, as compared to conventional systems. In some embodiments, the geometry or shape of the edges of the light pipe 706 may be optimized. In some embodiments, the shape of the light pipe 706 may be a curved truncated pyramid. In some embodiments, the shape of the light pipe 706 may not follow a particular defined shape, for example, the shape of the light pipe 706 may be a freeform curve. In some embodiments, the light pipe 706 can be configured to project light in a shape that matches a shape of a target area. Generally, the light pipe 706 can be used to collect the maximum amount of light from the light source 702. Advantageously, for embodiments with a multispectral light source, the light pipe 706 is configured to provide color mixing including the combination of multiple colors. As shown in FIG. 15, each light assembly 700 may include a light pipe 706. Accordingly, in a vision system with a plurality of light assemblies 700, each light assembly may include a light pipe 706.

The light pipe assembly 704 shown in FIG. 15 also include a first lens 708 that is positioned directly on the exit surface 712 of the light pipe 706. Advantageously, the first lens 708 of the light pipe assembly 704 provides a third optical surface in the light assembly 700. In some embodiments, the light pipe 706 and the first lens 708 can advantageously be formed or molded or formed as a unitary body or piece. Accordingly, the first lens 708 may be integrated with the light pipe 706. In the embodiment of FIG. 15, the first lens 708 of the light pipe assembly 704 can have a dome shape. In some embodiments, the first lens 708 may have other shapes. Using a light pipe assembly 704 that includes a light pipe 706 and a first lens 708 formed as a unitary body can reduce cost. In addition, with one mold, an optical component (i.e., the light pipe assembly 704) can be created that can both mix color and be part of the imaging path.

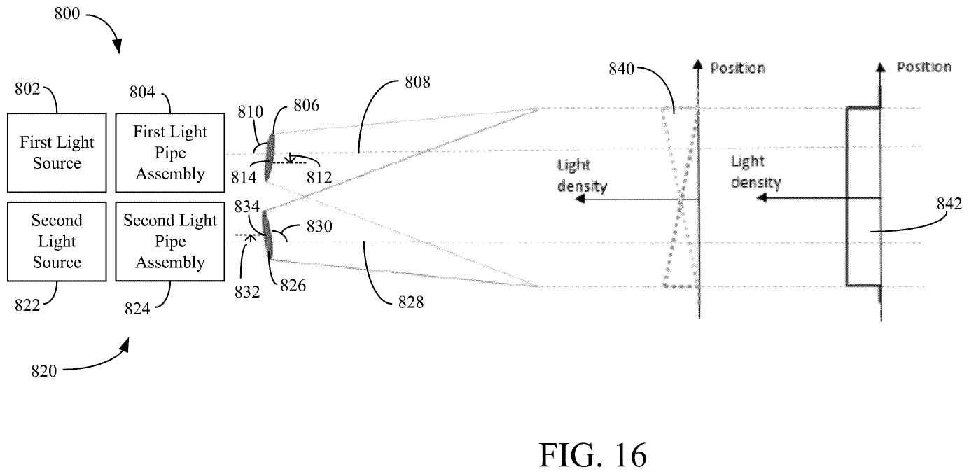

The second lens 716 may be positioned in front of the light pipe assembly 704. The second lens 716 can have a first surface 718 and a second surface 720. In some embodiments, the first surface 718 and the second surface 720 can have an aspherical shape. An aspherical shape for the first 718 and second 720 surfaces of the second lens 716 can help provide on-axis optimization and can improve the overlap of different projections. The second lens 716 can receive light (for example, color mixed light or monochromatic light), from the light pipe assembly 704 and project a light beam using the light onto a target area 728. Advantageously, the two elements illumination optics assembly (e.g., the light pipe assembly 704 and second lens 716) can provide direct light. In some embodiments, a center point 726 of the second lens 716 can be spatially shifted (e.g., shift 724) with respect to the optical axis 714 of the light pipe 706. In addition, the second lens 716 can have a tilt angle (θ) 722 with respect to the optical axis 714 of the light pipe 706. The second lens 716 can project a light beam in the target area 728 to acquire an image in the image plane 730. In some embodiments, the tilt angle 722 and the spatial shift 724 of the second lens 716 can be selected to acquire an image 732 that is shifted from the optical axis 714 of the light pipe 706. In some embodiments where a plurality of light assemblies 700 are used in an illumination assembly, the tilt angle 722 and spatial shift 724 of each second lens in each illumination optics assembly can advantageously be selected so that the target area 728 onto which the light beam is projected from each second lens is the same area as discussed further below with respect to FIGS. 16 and 17. Advantageously, the combination of the light pipe 706, the first lens 708 and the second lens 716 can enable uniform color mixing (e.g., for a multispectral light source) and project uniform light patterns with compact dimensions of the illumination optics. In some embodiments, the light distribution and color mixing (e.g., for a multispectral light source) in the target area 728 of the light assembly 700 may be configured for a working distance less than 1 meter. In some embodiments, the light distribution and color mixing in the target area 728 of the light assembly 700 may be configured for a working distance greater than or equal to 1 meter. Accordingly, various embodiments of the light assembly 700 may advantageously be used for a wide range of different working distances.

FIG. 16 is a schematic diagram of an example arrangement of two light assemblies of FIG. 15 for an illumination assembly in accordance with an embodiment of the technology. As mentioned above, in some embodiments where a plurality of light assemblies 700 are used in an illumination assembly, the tilt angle 722 and spatial shift 724 of each second lens in each illumination optics assembly can advantageously be selected so that the target area 728 onto which the light beam is projected from each second lens is the same area. In FIG. 16, for simplicity, two light assemblies (i.e., first light assembly 800 and second light assembly 820) are shown, however, it should be understood that more than two light assemblies can be used in an illumination assembly for a machine vision system. The first light assembly includes a first light source 802 (e.g., a monocolor light source of a multispectral light source), a first light pipe assembly 804 and a lens 806. The second light assembly 820 includes a second light source 822 (e.g., a monocolor light source or a multispectral light source), a second light pipe assembly 824 and a lens 826. As discussed above with respect to FIG. 15, the first light pipe assembly 804 and the second light pipe assembly 824 can each include a light pipe and a lens on an exit surface of the light pipe. Lens 806 can receive light (e.g., color mixed or monochromatic light) from the first light pipe assembly 804 and can project a light beam that includes the light onto a target area 840. Lens 806 of the first light assembly 800 can have a tilt angle 810 and a spatial shift 812 with respect to an optical axis 808 of the first light pipe assembly 804. In some embodiments, a center point 814 of the lens 806 can be spatially shifted (e.g., shift 812) with respect to the optical axis 808 of the first light pipe assembly 804. Lens 826 can receive light (e.g., color mixed or monochromatic light) from the second light pipe assembly 824 and can project a light beam that includes the light onto the target area 840. Lens 826 of the second light assembly 820 can have a tilt angle 830 and a spatial shift 832 with respect to an optical axis 828 of the second light pipe assembly 820. In some embodiments, a center point 834 of the lens 826 can be spatially shifted (e.g., shift 832) with respect to the optical axis 828 of the second light pipe assembly 824. Advantageously, in some embodiments, the tilt angle 810 and shift 812 of lens 806 of the first light assembly 800 and the tilt angle 830 and shift 823 of the lens 826 of the second light assembly 820 can be selected so that the light beam projected by lens 806 and lens 826 is projected onto the same target area 840. In some embodiments, the tilt angles 810 and 830 have different values and the shifts 812 and 832 have different values. In some embodiments, one or more of the tilt angles or shifts may be the same. Light assemblies 800 and 820 can be configured to reduce (e.g., minimize) an amount of light (e.g., stray light) projected outside of the target area 840. In addition, the positions and selected tilt angles 810, 830 and shifts 812, 832 for each light assembly 800, 820 in an illumination assembly can be selected so that a sum of the light distribution of each light beam projected by each lens 806, 826 on the target area 840 is homogeneous (e.g., power/area and color/area) as illustrated in FIG. 16 by light distribution profile 842. For example, as mentioned, the tilt angles 810, 830 and shifts 812, 832 can be selected so that the lenses 806 and 826 illuminate the same area which can help achieve homogeneity. As used herein, a homogeneous light distribution indicates that the light distribution over the target area is flat or substantially flat (e.g., a high degree of homogeneity such as greater than 80%).

FIG. 17 is a perspective view of an example arrangement of a plurality of light assemblies of FIG. 15 for an illumination assembly in accordance with an embodiment of the technology. The light assemblies 902 of the illumination assembly are shown in an example arrangement 900 in FIG. 17 and it should be understood that different numbers and other arrangements me be used in an illumination assembly in other embodiments. In various embodiments, multiple illumination patterns can be achieved. In addition, different positions and arrangements of the light assemblies 902 can be used to fulfill the mechanical and optical requirements of different applications. In some embodiments, the plurality of light assemblies 902 may be disposed around an opening 910 for, for example, an imaging optics assembly (not shown). In the example illustrated in FIG. 17, the light assemblies 902 are disposed around the opening 910 in banks. For example, the light assemblies 902 can be arranged in a north bank 912, a south bank 914, an cast bank 916 and a west bank 918. As discussed above with respect to FIGS. 15 and 16, each light assembly 902 can include a light source 904 (e.g., a monocolor light source or a multispectral light source), and an illumination optics assembly having a light pipe assembly 906 that includes a light pipe and a first lens disposed on an exit surface of the light pipe and a lens 908 that may have a spatial shift and a tilt angle with respect to the optical axis of the corresponding light pipe. As discussed above with respect to FIGS. 15 and 16, the spatial shift and tilt angle of each lens 908 of each light assembly 902 in the arrangement 900 can be selected so that the target area (not shown) onto which a light beam is projected from each lens 908 is the same area. In some embodiments, an arrangement 900 of light sources 902 may be used in an illumination assembly as discussed above with respect to, for example, FIGS. 1 and 3B. The position of each light assembly 902 in arrangement 900, as well as each selected tilt angle and spatial shift for each lens 908 can advantageously be selected so that a sum of the light distribution of each light beam projected by each lens 908 on the target area (not shown) is homogeneous. An illumination system utilizing light assemblies with the disclosed two element illumination optics assembly can achieve a low cost, homogeneous and bright illumination and can compensate for, for example, eventual occlusion or limited installation space due to, for example, the positions of sensor or mechanical components.

In some embodiments, an illumination device for illuminating a target area can include a plurality of light assemblies. Each light assembly can include a light source configured to generate light and a light pipe assembly. In some embodiments, the light pipe assembly can be formed as a unitary body and can include a light pipe having an entrance surface parallel to the light source, an exit surface and an optical axis centered on the light source. The light pipe can be positioned in front of the light source along the optical axis. The light pipe assembly can also include a first lens and a second lens. The first lens can be positioned on the exit surface of the light pipe. The second lens can be positioned with a spatial shift and a tilt angle relative to the optical axis and configured to project a light beam using light from the light pipe assembly. The spatial shift and the tilt angle each second lens of each light assembly [projects the respective light beam to the target area onto such that the plurality of light assemblies outputs a homogeneous light distribution at the target area. The plurality of light assemblies reduces an amount of stray light with respect to the target area.

In some embodiments, the light source is one of a monocolor light source or a multicolor light source. In some embodiments, the first lens can have a dome shape. In some embodiments, the light beam projected by each second lens is direct light. In some embodiments, the second lens has a first aspherical surface and a second aspherical surface. In some embodiments where the light source is a multispectral light source, the light pipe assembly can be configured to output color mixed light by mixing at least a first wavelength of light with a second wavelength of light. In some embodiments, the light source is a multispectral light source that can include a plurality of color light emitting diodes (LEDs), each color LED configured to provide a different wavelength of light. In some embodiments, the multispectral light source can be one of an RGBW, LED, an RGB IR LED, or an RGBY LED. In some embodiments, the illumination assembly can also include an illumination assembly processor device that is in communication with the plurality of light assemblies and can be configured to control the activation of each light source.

In some embodiments, a machine vision system can include an optics assembly having a lens, a sensor assembly including an image sensor, and an illumination assembly including a plurality of light assemblies. Each light assembly can include a light source configured to generate light and a light pipe assembly. The light pipe assembly can be formed as a unitary body and can include a light pipe having an entrance surface parallel to the light source, an exit surface and an optical axis centered on the light source. The light pipe can be positioned in front of the light source along the optical axis. The light pipe assembly can also include a first lens and a second lens. The first lens can be positioned on the exit surface of the light pipe. The second lens can be positioned with a spatial shift and at a tilt angle relative to the optical axis and can be configured to project a light beam using the light from the light pipe assembly. The spatial shift and the tilt angle of each second lens of each light assembly can project the respective light beam to a target area such that the plurality of light assemblies outputs a homogeneous light distribution. The plurality of light assemblies can reduce an amount of stray light with respect to the target area. The machine vision system can also include a processor device in communication with the optics assembly, the sensor assembly and the illumination assembly. The processor device can be configured to control activation of each light source.

In some embodiments, the light source is one of a monocolor light source or a multicolor light source. In some embodiments, the first lens can have a dome shape. In some embodiments, the light beam projected by each second lens is direct light. In some embodiments, the second lens can have a first aspherical surface and a second aspherical surface. In some embodiments, the light source can be a multispectral light source that can include a plurality of color light emitting diodes (LEDs), each color LED configured to provide a different wavelength of light. In some embodiments, the multispectral light source can be one of an RGBW, LED, an RGB IR LED, or an RGBY LED.

In some embodiments, an illumination assembly for illuminating a target area can include a housing that includes a first shelf defining a first position within the housing and a second shelf defining a second position within the housing. The illumination assembly can also include a circuit board disposed within the housing, a plurality of light sources disposed within the housing and configured to be coupled to the circuit board and a plurality of illumination optics assemblies disposed within the housing and removably coupled to the housing. Each illumination optics assembly corresponding to one of the plurality of light sources can include a light pipe assembly. The light pipe assembly can be formed as a unitary body and can include a light pipe having an entrance surfacer parallel to the corresponding light source, an exit surface and an optical axis centered on the corresponding light source. The light pipe can be positioned in front of the corresponding light source along the optical axis. The light pipe assembly can also include a first lens and a second lens. The first lens can be positioned on the exit surface of the light pipe. The second lens can be positioned with a spatial shift and at a tilt angle relative to the optical axis and can be configured to project a light beam using light from the light pipe assembly. The housing can be configured to support the circuit board at one of the first position or the second position within the housing based on an illumination optics assembly type of the plurality of illumination optics assemblies. In some embodiments, the illumination assembly can also include a cover positioned in front of the housing and coupled to the housing. In some embodiments, the illumination assembly can include a thermal control assembly thermally coupled to the circuit board. In some embodiments, the spatial shift and the tilt angle of each second lens of each illumination optics assembly can project the respective light beam to the target area such that the plurality of illumination optics assemblies outputs a homogeneous light distribution at the target area. In some embodiments, the plurality of illumination optics assemblies reduces an amount of stray light with respect to the target area.

The foregoing has been a detailed description of illustrative embodiments of the technology. Various modifications and additions can be made without departing from the spirit and scope of this disclosure. Features of each of the various embodiments described above may be combined with features of other described embodiments as appropriate in order to provide a multiplicity of feature combinations in associated new embodiments. Furthermore, while the foregoing describes a number of separate embodiments of the apparatus and method of the present disclosure, what has been described herein is merely illustrative of the application of the principles of the present disclosure. Also, as used herein various directional and orientation terms such as “vertical”, “horizontal”, “up”, “down”, “bottom”, “top”, “side”, “front”, “rear”, “left”, “right”, and the like are used only as relative conventions and not as absolute orientations with respect to a fixed coordinate system, such as gravity. Accordingly, the description is meant to be taken only by way of example, and not to otherwise limit the scope of this disclosure.

In some embodiments, aspects of the technology, including computerized implementations of methods according to the technology, can be implemented as a system, method, apparatus, or article of manufacture using standard programming or engineering techniques to produce software, firmware, hardware, or any combination thereof to control a processor device (e.g., a serial or parallel general purpose or specialized processor chip, a single- or multi-core chip, a microprocessor, a field programmable gate array, any variety of combinations of a control unit, arithmetic logic unit, and processor register, and so on), a computer (e.g., a processor device operatively coupled to a memory), or another electronically operated controller to implement aspects detailed herein. Accordingly, for example, embodiments of the technology can be implemented as a set of instructions, tangibly embodied on a non-transitory computer-readable media, such that a processor device can implement the instructions based upon reading the instructions from the computer-readable media. Some embodiments of the technology can include (or utilize) a control device such as an automation device, a special purpose or general-purpose computer including various computer hardware, software, firmware, and so on, consistent with the discussion below. As specific examples, a control device can include a processor, a microcontroller, a field-programmable gate array, a programmable logic controller, logic gates etc., and other typical components that are known in the art for implementation of appropriate functionality (e.g., memory, communication systems, power sources, user interfaces and other inputs, etc.).

The term “article of manufacture” as used herein is intended to encompass a computer program accessible from any computer-readable device, carrier (e.g., non-transitory signals), or media (e.g., non-transitory media). For example, computer-readable media can include but are not limited to magnetic storage devices (e.g., hard disk, floppy disk, magnetic strips, and so on), optical disks (e.g., compact disk (CD), digital versatile disk (DVD), and so on), smart cards, and flash memory devices (e.g., card, stick, and so on). Additionally, it should be appreciated that a carrier wave can be employed to carry computer-readable electronic data such as those used in transmitting and receiving electronic mail or in accessing a network such as the Internet or a local area network (LAN). Those skilled in the art will recognize that many modifications may be made to these configurations without departing from the scope or spirit of the claimed subject matter.

Certain operations of methods according to the technology, or of systems executing those methods, may be represented schematically in the FIGS., or otherwise discussed herein. Unless otherwise specified or limited, representation in the FIGS. of particular operations in particular spatial order may not necessarily require those operations to be executed in a particular sequence corresponding to the particular spatial order. Correspondingly, certain operations represented in the FIGS., or otherwise disclosed herein, can be executed in different orders than are expressly illustrated or described, as appropriate for particular embodiments of the technology. Further, in some embodiments, certain operations can be executed in parallel, including by dedicated parallel processing devices, or separate computing devices configured to interoperate as part of a large system.

As used herein in the context of computer implementation, unless otherwise specified or limited, the terms “component,” “system,” “module,” and the like are intended to encompass part or all of computer-related systems that include hardware, software, a combination of hardware and software, or software in execution. For example, a component may be, but is not limited to being, a processor device, a process being executed (or executable) by a processor device, an object, an executable, a thread of execution, a computer program, or a computer. By way of illustration, both an application running on a computer and the computer can be a component. One or more components (or system, module, and so on) may reside within a process or thread of execution, may be localized on one computer, may be distributed between two or more computers or other processor devices, or may be included within another component (or system. module, and so on).

1. An illumination assembly for a machine vision system, the illumination assembly comprising:
a housing comprising a first shelf defining a first position within the housing and a second shelf defining a second position within the housing;
a circuit board disposed within the housing;
a plurality of light sources disposed within the housing and configured to be coupled to the circuit board; and
a plurality of illumination optics assemblies disposed within the housing and removably coupled to the housing, each illumination optics assembly corresponding to one of the plurality of light sources;
wherein the housing is configured to support the circuit board at one of the first position or the second position within the housing based on an illumination optics assembly type of the plurality of illumination optics assemblies.

2. The illumination assembly according to claim 1, further comprising a cover positioned in front of the housing and coupled to the housing, wherein the cover comprises a plurality of openings configured to receive the plurality of illumination optics assemblies.

3. The illumination assembly according to claim 1, wherein the light source is a mono-color light source, each of the illumination optics assemblies comprises a lens, and the circuit board is located at the first position within the housing.

4. The illumination assembly according to claim 3, wherein the lens is one of a wide field of view (FOV) lens, a standard FOV lens, a narrow FOV lens, or an elliptical FOV lens.

5. The illumination assembly according to claim 1, wherein the light source is a multispectral light source.

6. The illumination assembly according to claim 5, wherein each of the illumination optics assemblies includes a light pipe and a projection lens and the circuit board is located at the second position within the housing.

7. The illumination assembly according to claim 1, wherein each of the illumination optics assemblies comprises:
a light pipe assembly formed as a unitary body comprising:
a light pipe having an entrance surface parallel to the light source, an exit surface and an optical axis centered on the light source, and the light pipe positioned in front of the light source along the optical axis; and
a first lens positioned on the exit surface of the light pipe; and
a second lens positioned with a spatial shift and a tilt angle relative to the optical axis and configured to project a light beam using light from the light pipe assembly;
wherein the spatial shift and the tilt angles of each second lens of each illumination optics assembly projects the respective light beam to a target area;
wherein the circuit board is located at the second position within the housing.

8. The illumination assembly according to claim 1, further comprising a thermal control assembly thermally coupled to the circuit board and comprising a heat conductor.

9. The illumination assembly according to claim 1, further comprising:
a distance sensor; and
an aimer.

10. A machine vision system comprising:
an image sensor assembly including an image sensor;
an imaging optics assembly comprising a lens, the imaging optics assembly coupled to the image sensor assembly; and
an illumination assembly coupled to the imaging optics assembly, the illumination assembly comprising:
a housing having an opening configured to receive the imaging optics assembly;
a circuit board disposed within the housing;
a plurality of light sources disposed within the housing and configured to be coupled to the circuit board; and
a plurality of illumination optics assemblies disposed within the housing and removably coupled to the housing, each illumination optics assembly corresponding to one of the plurality of light sources;
wherein the housing is configured to support the circuit board at multiple positions within the housing based on an illumination optics assembly type of the plurality of illumination optics assemblies.

11. The machine vision system according to claim 10, wherein the light source is a multispectral light source.

12. The machine vision system according to claim 10, further comprising an illumination sensor positioned to detect light transmitted from the illumination assembly and configured to measure the intensity of the detected light.

13. The machine vision system according to claim 12, further comprising an illumination assembly processor device in communication with the plurality of light sources, the illumination assembly processor device configured to control activation of the plurality of light sources based on the measured intensity of the detected light.

14. The machine vision system according to claim 10, further comprising an illumination assembly processor device in communication with the plurality of light sources, wherein each of the plurality of light sources is a multispectral light source having a plurality of color LED dies, and wherein the illumination assembly processor device is configured to perform at least one of activating the color LED dies in a predetermined order or adjusting an exposure of the plurality of color LED dies.

15. The machine visions system according to claim 14, wherein the illumination assembly processor device is configured to activate the plurality of color LED dies in the predetermined order during a single exposure time or adjust an exposure time of the plurality of color LED dies during a single exposure time.

16. The machine vision system according to claim 10, further comprising an illumination assembly processor device in communication with the plurality of light sources, wherein the illumination assembly processor device is configured to selectively activate a subset of the plurality of light sources in an illumination pattern corresponding to a desired field of view (FOV).

17. The machine vision system according to claim 16, wherein the FOV is one of a wide FOV, an intermediate FOV, or a narrow FOV.

18. The machine vision system according to claim 16, further comprising an image sensor assembly processor device, wherein the image sensor assembly processor device is configured to determine the illumination pattern and the desired FOV based on a working distance.

19. The machine vision system according to claim 18, wherein the illumination assembly further includes a distance sensor configured to determine the working distance.

20. A method for manufacturing an illumination assembly, the method comprising:
providing a housing comprising a first shelf defining a first position within the housing and a second shelf defining a second position within the housing;
selecting one of the first shelf or the second shelf based on a predetermined illumination optics assembly type for the illumination assembly;
positioning a circuit board on the selected one of the first shelf and the second shelf, the circuit board comprising a plurality of light sources removably coupled to the circuit board; and
positioning a set of illumination optics assemblies of the predetermined illumination optics assembly type in the housing, wherein each illumination optics assembly corresponds to one of the light sources and is disposed on top of the corresponding light source.

21. The method according to claim 20, further comprising:
positioning a thermal control assembly on the selected one of the first shelf or the second shelf; and
positioning the circuit board in contact with the thermal control assembly.
